(19) United States
(12) Patent Application Publication
(10) Pub. No.: US 2009/0102083 A1
(43) Pub. Date: Apr. 23, 2009

(54) Method and System for Wavelength Specific Thermal Irradiation and Treatment

(76) Inventors: Don W. Cochran, Gates Mills, OH (US); Noel E. Morgan, JR., North Olmsted, OH (US); Denwood F. Ross, III, Austinburg, OH (US); Mark W. Moore, Aurora, OH (US)

Correspondence Address: Fay Sharpe LLP, 1228 Euclid Avenue, 5th Floor, The Halle Building, Cleveland, OH, 44115, US

(21) Appl. No.: 12/135,739

(22) Filed: Jun. 9, 2008

Related U.S. Application Data
(60) Provisional application No. 60/933,818, filed on Jun. 8, 2007.

(51) Int. Cl. B29C 49/78

(52) U.S. Cl. 264/40.6; 425/170

(57) ABSTRACT

A system for direct injection of selected, narrow bandwidth thermal-infrared (IR) radiation or energy into articles for a wide range of processing purposes is provided. The irradiation wavelengths are selected according to the specific absorption band characteristics of the target entity to create the desired efficiency of thermal transfer. The applications of the invention may include heating, raising or maintaining the temperature of articles, or stimulating a target item in a range of different industrial, medical, consumer, or commercial circumstances. The system is especially applicable to operations that require or benefit from the ability to irradiate at specifically selected mid-infrared wavelengths or to pulse or inject the radiation. The system is particularly advantageous when functioning at higher speeds and in a non-contact environment with the target.

This application is based on and claims priority to U.S. Provisional Patent Application No. 60/933,818, filed Jun. 8, 2007, which is incorporated in its entirety herein by reference.

### RELATED APPLICATIONS

This application is related to U.S. Ser. No. 11/003,679, filed Dec. 3, 2004, entitled “A Method and System for Wavelength Specific Thermal Irradiation and Treatment,” U.S. Ser. No. 11/351,030, filed Feb. 9, 2006, entitled “A Method and System for Wavelength Specific Thermal Irradiation and Treatment,” and U.S. Ser. No. 11/448,630, filed Jun. 7, 2006, entitled “A Method and System for Laser-Based, Wavelength Specific Infrared Irradiation Treatment,” all three of which applications are incorporated herein by reference.

### BACKGROUND OF THE INVENTION

This invention relates to the direct injection of selected thermal-infrared (IR) wavelength radiation or energy into targeted entities for a wide range of heating, processing, or treatment purposes. As will be described below, these purposes may include heating, raising or maintaining the temperature of articles, or stimulating a target item in a range of different industrial, medical, consumer, or commercial circumstances. The methods and system described herein are especially applicable to operations that require or benefit from the ability to irradiate at specifically selected wavelengths or to pulse or inject the radiation. The invention is particularly advantageous when the target is moving at higher speeds and in a non-contact environment with the target. The invention provides for an infrared system of selected narrow wavelengths which is highly programmable for a wide range of end applications. The irradiation system, includes, in at least one form, a plurality of narrow band irradiation sources which are configured to irradiate targets at wavelengths that match particular absorptive qualities of the targets. In one form, the invention teaches a new and novel type of infrared irradiation system which is comprised of engineered arrays of most preferably a new class of narrow wavelength solid-state radiation emitting devices (REDs), one variant of which will be specifically referenced later in this document. These devices and alternatives or variants are described herein for example purposes, but may take a variety of forms which could include many forms of narrow band irradiation sources such as diodes, laser diodes (or other types of laser devices) or other solid state emitting devices.

More specifically, this invention is directed to a novel and efficient way of injecting an optimal wavelength of infrared radiation into a target for the purpose of, in some way, affecting the target's temperature. To cite a small sampling of examples, the “target” for the infrared injection may be from a wide variety of items ranging from individual components in a manufacturing operation, to a region of treatment on a continuous coil of material, to food in a cooking process, or to human patients in a medical treatment environment.

Though the specific embodiment of the invention described hereafter is an example that relates particularly to a plastic bottle preform reheat operation, the concepts contained within also apply to many other noted scenarios. It also applies to single-stage plastic bottle blowing operations wherein the injection-molding operation is performed serially, just prior to the blow-molding operation. In this deployment, for example, the methods and apparatus of the subject invention offer similar advantages over the known art, but would employ different sensing and controls to deal with the variation in initial temperature at the entrance to the reheat section of the process.

In general, an ideal infrared heating system optimally raises the temperature of a target with the least energy consumption. Such a system may comprise a device that can directly convert its electrical power input to a radiant electromagnetic energy output, with the chosen single or narrow band wavelengths that are aimed at a target, such that the energy comprising the irradiation is partially or fully absorbed by the target and converted to heat. The more efficiently the electrical input is converted to radiant electromagnetic output, the more efficiently the system can perform. The more efficiently the radiant electromagnetic waves are aimed to expose only the desired areas on the target, the more efficiently the system will accomplish its work. The radiation emitting device chosen for use should have an instant “on” and instant “off” characteristic such that when the target is not being irradiated, neither the input nor the output energy is wasted. The more efficiently the exposed target absorbs the radiant electromagnetic energy to directly convert it to heat, the more efficiently the system can function. For an optimal system, care must be taken to properly select so that the set of system output wavelengths matches the absorptive characteristic of the target. These wavelengths likely will be chosen differently for different targeted applications of the invention to best suit the different absorption characteristics of different materials as well as to suit different desired results.

In contrast, it is well known in the art and industry to use a range of different types of radiant heating systems for a wide range of processes and treatments. Technologies that have been available previously for such purposes produce a relatively broad band spectrum of emitted radiant electromagnetic energy. They may be referred to as infrared heating, treatment, or processing systems whereas, in actual fact, they often produce radiant energy well outside the infrared spectrum.

The infrared portion of the spectrum is generally divided into three wavelength classifications. These are generally categorized as near-infrared, middle-infrared, and long-infrared wavelengths bands. While exact cutoff points are not clearly established for these general regions, it is generally accepted that the near-infrared region spans the range between visible light and 1.5 micrometers. The middle-infrared region spans the range from 1.5 to 5 micrometers. The long-wave-infrared region is generally thought to be between 5 and 14 micrometers and beyond.

The radiant infrared sources that have been used in industrial, commercial, and medical, heating treatment or process equipment previously produce a broad band of wavelengths which are rarely limited to one section of the infrared spectrum. Although their broad band output may peak in a particular range of the infrared spectrum, they typically have an output tail which extends well into adjacent regions.

As an example, quartz infrared heating lamps, which are well known in the art and are used for various process heating operations, will often produce a peak output in the 0.8 to 1 micrometer range. Although the output may peak between 0.8 and 1 micrometers, these lamps have substantial output in a wide continuous set of wavelength bands from the ultraviolet (UV) through the visible and out to about 3.5 micrometers in the middle-infrared. Clearly, although the peak output of a quartz lamp is in the near-infrared range, there is substantial output in both the visible range and in the mid-infrared ranges. It is, therefore, not possible with the existing broad spectrum infrared sources to be selective as to the preferred wavelength or wavelengths that would be the most desired for any given heating, processing or treatment application. It is inherently a wide spectrum treatment or process and has been widely used because there have not been practical alternatives before, for example, the developments of the above-noted related applications. The primary temperature rise in many targets is due to absorption of thermal IR energy at one or more narrow bands of wavelengths. Thus, much of the broadband IR energy output is wasted.

Nonetheless, quartz infrared lights are widely used in industry for both the discrete components and the continuous material processing industries. A variety of methodologies would typically be used to help direct the emission from the quartz lamps onto the target under process including a variety of reflector-types. Regardless of how the energy is focused onto the target, the quartz lamps are typically energized continuously. This is true whether the target under process is a continuously produced article or discrete components. The reason for this is primarily due to the relatively slow thermal response time of quartz lamps which typically measure on the order of seconds.

An area of specific need for improved energy injection relates to blow molding operations. More specifically, plastic bottle stretch blow-molding systems thermally condition preforms prior to stretch blow molding operations. One aspect of this process is known in the art as a reheat operation. In a reheat operation, preforms that have been formed by way of an injection molding or compression molding process are allowed to thermally stabilize to room temperature. At a later time, the preforms are fed into a stretch blow molding system, an early stage of which heats up the preforms to a temperature wherein the thermoplastic preform material is at a temperature optimized for subsequent blow-molding operations. This condition is met while the preforms are being transported through a heating section along the path to the blow molding section of the machine. In the blow molding section, the preforms are first mechanically stretched and then blown into vessels or containers of larger volume.

Energy consumption costs make up a large percentage of the cost of a finished article that is manufactured using blow molding operations. More specifically, the amount of energy required with the heretofore state-of-the-art technology to heat up or thermally condition Polyethylene Terephthalate (PET) preforms from ambient temperature to 105° C. in the reheat section of a stretch blow molding machine is quite substantial. From all manufacturing efficiently measures, it will be clearly advantageous from both an economic and an environmental standpoint to reduce the energy consumption rate associated with the operation of the thermal conditioning section of stretch blow molding systems.

To further explain, current practice is to expose the containers to radiant energy from a multitude of quartz infrared W-VII lamps, organized into a tunnel. The energy from each lamp is crudely variable, thus providing for a very small measure of adjustability to the irradiance on different segments of the container. Much of the energy from the lamps is not absorbed by the container at all, or is absorbed into the ambient air, and mechanical supports, thus lowering overall efficiency significantly. Some effort is made to mitigate the undesirable heating; air is blown around the tunnel in an effort to 1) cool the outer skin of the container (which is desirable), and 2) couple more energy into the containers by convection through the unnecessarily heated air.

The disadvantages of the current method are the unnecessary heating of air and adjacent structures, poor tuning ability of the irradiance distribution on the container, large physical space requirements, the inability to selectively heat specific spots or bands on the preforms, the reduced ability to quickly adapt heating distribution to new requirements, such as a lot changeover to different sized containers, and consequential problems generated by the same. For instance, incomplete absorption of the light by the container preform causes more service power for the tunnel, more service power to remove the excess heat from ambient inside the plant, more space for the tunnel to allow for more gradual and uniform heating, more frequent service intervals for burnt out bulbs, and more variability in the heating from un-even bulb deterioration.

U.S. Pat. No. 5,322,651 describes an improvement in the method for thermally treating thermoplastic preforms. In this patent, the conventional practice of using broadband infrared (IR) radiation heating for the thermal treatment of plastic preforms is described. Quoting text from this patent, “In comparison with other heating or thermal treatment methods such as convection and conduction, and considering the low thermal conductivity of the material, heating using infrared radiation gives advantageous output and allows increased production rates.”

The particular improvement to the state-of-the-art described in this patent relates to the manner in which excess energy emitted during IR heating of the preforms is managed. In particular, this patent concerns itself with energy emitted during the heating process that ultimately (through absorption in places other than the preforms, conduction, and then convection) results in an increase in the air temperature in the oven volume surrounding the transported preforms. Convection heating of the preforms caused by hot air flow has proven to result in non-uniform heating of the preforms and, thus, has a deleterious effect on the manufacturing operation. U.S. Pat. No. 5,322,651 describes a method of counteracting the effects of the unintended heating of the air flow surrounding the preforms during IR heating operations.

As might be expected, the transfer of thermal energy from historical state-of-the-art IR heating elements and systems to the targeted preforms is not a completely efficient process. Ideally, 100% of the energy consumed to thermally condition preforms would end up within the volume of the preforms in the form of heat energy. Although it was not specifically mentioned in the above referenced patent, typical conversion efficiency values (energy into transported preforms/energy consumed by IR heating elements) in the range between 5% and 10% are claimed by the current state-of-the-art blow molding machines. Any improvement to the method or means associated with the infrared heating of preforms that improves the conversion efficiency values would be very advantageous and represents a substantial reduction in energy costs for the user of the stretch blow forming machines.

There are many factors that work together to establish the energy conversion efficiency performance of the IR heating elements and systems used in the current state-of-the-art blow molding machines. As noted, conventional thermoplastic preforms, such as PET preforms, are heated to a temperature of about 105° C. This is typically accomplished in state-of-the-art blow molding machines using commercially available broadband quartz infrared lamps. In high-speed/high-production machines these often take the form of large banks of very high wattage bulbs. The composite energy draw of all the banks of quartz lamps becomes a huge current draw amounting to many hundreds of kilowatts on the fastest machines. Two factors associated with these types of IR heating elements that have an effect on the overall energy conversion efficiency performance of the overall heating system are the color temperature of the lamp filament and the optical transmission properties of the filament bulb.

Another factor that has a significant impact on the overall energy conversion performance of the thermal conditioning subsystems of the current state-of-the-art blow molding machines is the flux control or lensing measures used to direct the IR radiation emitted by the heating elements into the volume of the preforms being transported through the system. In most state-of-the-art blow molding machines, some measures to direct the IR radiant flux emitted by quartz lamps into the volume of the preforms are being deployed. In particular, metallized reflectors work well to reduce the amount of emitted IR radiation that is wasted in these systems.

Still another factor that has an impact on the energy conversion efficiency performance of the IR heating subsystem is the degree to which input energy to the typically stationary IR heating elements is synchronized to the movement of the preforms moving through the heating system. More specifically, if a fixed amount of input energy is continuously consumed by a stationary IR heating element, even at times when there are no preforms in the immediate vicinity of the heater due to continuous preform movement through the system, the energy conversion efficiency performance of the systems is obviously not optimized. In practice, the slow physical response times of commercial quartz lamps and the relatively fast preform transfer speeds of state-of-the-art blow molding machines precludes any attempt of successfully modulating the lamp input power to synchronize it with discrete part movement and, thus, achieve an improvement in overall energy conversion efficiency performance.

U.S. Pat. No. 5,925,710, U.S. Pat. No. 6,022,920, and U.S. Pat. No. 6,503,586 B1 all describe similar methods to increase the percentage of energy emitted by IR lamps that is absorbed by transported preforms used in a blow molding process. All of these patents describe, in varying amounts of detail, the general practice in state-of-the-art reheat blow molding machines to use quartz lamps as the IR heating elements. In a reheat blow molding process, preforms that have previously been injection molded and allowed to stabilize to room temperature are reheated to blowing temperatures just prior to blow molding operations. These above reference patents describe how polymers in general, and PET in particular, can be heated more efficiently by IR absorption than is possible using conduction or convection means. These patents document in figures the measured absorption coefficient of PET as a function of wavelength. Numerous strong molecular absorption bands occur in PET, primarily in IR wavelength bands above 1.6 micrometer. Quartz lamps are known to emit radiation across a broad spectrum, the exact emission spectrum being determined by the filament temperature as defined by Planck's Law.

As used in existing state-of-the-art blow molding machines, quartz lamps are operated at a filament temperature of around 3000° K. At this temperature, the lamps have a peak radiant emission at around 0.8 micrometer. However, since the emission is a blackbody type emission, as it is known in the art, the quartz filament emits a continuous spectrum of energy from X-ray to very long IR. At 3000° K., the emission rises through the visible region, peaks at 0.8 micrometer, and then gradually decreases as it begins to overlap the regions of significant PET absorption starting at around 1.6 micrometer.

What is not described in any of these patents is the effect that the quartz bulb has on the emitted spectrum of the lamp. The quartz material used to fabricate the bulb of commercial quartz lamps has an upper transmission limit of approximately 3.5 micrometer. Beyond this wavelength, any energy emitted by the enclosed filament is, for the most part, absorbed by the quartz glass sheath that encloses the filament and is therefore not directly available for preform heating.

For the reasons outlined above, in existing state-of-the-art blow molding machines that use quartz lamps to reheat PET preforms to blowing temperatures, the range of absorptive heating takes place between 1 micrometer and 3.5 micrometer. The group of patents referenced above (U.S. Pat. No. 5,925,710, U.S. Pat. No. 6,022,920, and U.S. Pat. No. 6,503,586 B1) all describe different method and means for changing the natural absorption properties of the preform, thus improving the overall energy conversion efficiency performance of the reheat process. In all of these patents, foreign materials are described as being added to the PET preform stock for the sole purpose of increasing the absorption coefficient of the mixture. These described methods and means are intended to impact the materials optical absorption properties in the range from the near IR around 0.8 micrometer out to 3.5 micrometer. While being a viable means of increasing the overall energy conversion efficiency performance of the reheat process, the change in the absorption property of the preforms that is so beneficial in reducing the manufacturing costs of the container also has a deleterious effect on the appearance of the finished container. A reduction in the optical clarity of the container, sometimes referred to as a hazing of the container, acts to make this general approach a non-optimal solution to this manufacturing challenge.

U.S. Pat. No. 5,206,039 describes a one-stage injection molding/blow molding system consisting of an improved means of conditioning and transporting preforms from the injection stage to the blowing stage of the process. In this patent, the independent operation of an injection molding machine and a blow molding machine, each adding a significant amount of energy into the process of thermally conditioning the thermoplastic material, is described as wasteful. This patent teaches that using a single-stage manufacturing process reduces both overall energy consumption rates and manufacturing costs. This reduction in energy consumption comes primarily from the fact that most of the thermal energy required to enable the blow molding operation is retained by the preform following the injection molding stage. More specifically, in a one-stage process as described in the '039 patent, the preform is not allowed to stabilize to room temperature after the injection molding process. Rather, the preforms move directly from the injection molding stage to a thermal conditioning section and then on to the blow molding section.

The thermal conditioning section described in the '039 patent has the properties of being able to add smaller amounts of thermal energy as well as subjecting the preforms to controlled stabilization periods. This differs from the requirements of a thermal conditioning section in the 2-stage process of a reheat blow-molding machine wherein large amounts of energy are required to heat the preforms to the blowing temperature. Though the operation of single-stage injection molding/blow molding machines are known in the art, finished container quality problems persist for these machines. These quality problems are linked to preform-to-preform temperature variations as the stream of preforms enters the blowing stage. Despite the advances described in the '039 patent, using heretofore state-of-the-art IR heating and temperature sensing means and methods, the process of thermally conditioning preforms shortly after they have been removed from an injection molding process still results in preforms of varying thermal content entering the blowing stage. The variations in thermal content of the entering preforms result in finished containers of varying properties and quality. Inefficiencies in the ability to custom tune the IR heating process on a preform-to-preform basis results in manufacturers opting to use a reheat blow molding method to achieve required quality levels. For this reason, for the highest production applications, the industry's reliance on reheat methods persists. Also, because preforms are often manufactured by a commercial converter and sold to an end user who will blow and fill the containers, the re-heat process continues to be popular.

The prospect of generally improving the efficiency and/or functionality of the IR heating section of blow molding machines is clearly advantageous from both an operating cost as well as product quality perspective. Though several attempts have been made to render improvements in the state-of-the-art IR heating subsystems, clear deficiencies still persist. Through the introduction of novel IR heating elements and methods, it is the intention of the present invention to overcome these deficiencies.

In the solid state electronics realm, solid-state emitters or LEDs are well known in the art. Photon or flux emitters of this type are known to be commercially available and to operate at various wavelengths from the ultraviolet (UV) through the near-infrared. LEDs are constructed out of suitably N- and P-doped semiconductor material. A volume of semiconductor material suitably processed to contain a P-doped region placed in direct contact with an N-doped region of the same material is given the generic name of diode. Diodes have many important electrical and photoelectrical properties as is well known in the art. For example, it is well known within the art that, at the physical interface between an N-doped region and a P-doped region of a formed semiconductor diode, a characteristic bandgap exists in the material. This bandgap relates to the difference in energy level of an electron located in the conduction band in the N-region to the energy level of an electron in a lower available P-region orbital. When electrons are induced to flow across the PN-junction, electron energy level transitions from N-region conduction orbitals to lower P-region orbitals begin to happen resulting in the emission of a photon for each such electron transition. The exact energy level or, alternately, wavelength of the emitted photon corresponds to the drop in energy of the conducted electron.

In short, LEDs operate as direct current-to-photon emitters. Unlike filament or other blackbody type emitters, there is no requirement to transfer input energy into the intermediate form of heat prior to being able to extract an output photon. Because of this direct current-to-photon behavior, LEDs have the property of being extremely fast acting. LEDs have been used in numerous applications requiring the generation of extremely high pulse rate UV, visible, and/or near IR light. One specific application wherein the high pulse rate property of LEDs has been particularly useful is in automated discrete part vision sensing applications, where the visible or near infrared light is used to form a lens focused image which is then inspected in a computer.

Unlike filament-based sources, LEDs emit over a relatively limited wavelength range corresponding to the specific bandgap of the semiconductor material being used. This property of LEDs has been particularly useful in applications wherein wavelength-selective operations such as component illumination, status indication, or optical communication are required. More recently, large clusters of LEDs have been used for larger scale forms of visible illumination or even for signaling lights such as automotive tail lights or traffic signal lights.

### SUMMARY OF THE INVENTION

The subject invention provides for the implementation of small or substantial quantities of infrared radiation devices that are highly wavelength selectable and can facilitate the use of infrared radiation for whole new classes of applications and techniques that have not been available historically.

An object of this invention is to provide a molding or other process or treatment system with a thermal IR heating method possessing improved IR energy conversion efficiency performance and decreased heating durations.

Another object of this invention is to provide heating systems having an advantageous configuration and achieving penetration depth performance tuned to the particular material being processed or targeted.

Another object of this invention is to provide a thermal IR radiation system which can incorporate an engineered mixture of narrow band irradiation sources, including REDs and types of diodes such as laser diodes, which produce IR radiation at such selected narrow wavelength bands as may be optimal for classes of applications.

Another object of this invention is to provide an IR heating system capable of being driven in a pulsed mode; said pulsed mode being particularly suited to providing IR heat to discretely manufactured parts as they are transported during the manufacturing process or to facilitate synchronous tracking of targets of the irradiation.

Another object of this invention is to provide IR heating elements that are more directable via metallized reflector elements.

Another object of this invention is to provide an IR heating system capable of working in conjunction with a preform temperature measurement system to provide preform-specific IR heating capability.

Another object of this invention is to provide IR heating elements that are fabricated as arrays of direct current-to-photon IR solid-state emitters or radiance emitting diodes (REDs) or other types of narrow band irradiation sources.

Yet another advantage of this invention is to provide an infrared irradiation system of substantial radiant output at highly specific single or multiple narrow wavelength bands.

Yet another advantage of this invention is the functionality to produce powerful, thermal infrared radiation and to be highly programmable for at least one of position, intensity, wavelength, turn-on/turn-off rates, directionality, pulsing frequency, and product tracking.

Yet another advantage of the invention is the facilitation of a more input energy efficient methodology for injecting heat energy compared to current broadband sources.

Yet another advantage of the invention in heating bottle preforms is in retaining the ability to heat efficiently without requiring additives which reduce the visible clarity and appearance qualities of the finished container.

Yet another object of this invention is to provide a general radiant heating system for a wide range of applications to which it can be adapted to provide the increased functionality of wavelength selective infrared radiation in combination with the programmability and pulsing capability.

Yet another advantage of this invention is the ability to facilitate extremely fast high intensity burst pulses with much higher instantaneous intensity than steady state intensity.

Yet another advantage of the invention is that waste heat can be easily conducted away to another location where it is needed or can be conducted out of the using environment to reduce non-target heating.

Yet another advantage of the invention is that the RED devices can be packaged in high density to yield solid state, thermal IR output power levels that have heretofore not been practically attainable.

### BRIEF DESCRIPTION OF THE DRAWINGS

FIG. 1 is a cross-sectional view of a portion of an exemplary semiconductor device implemented in one embodiment of the present invention.

FIG. 2 is a cross-sectional view of a buffer layer of an exemplary semiconductor device implemented in one embodiment of the present invention.

FIG. 3 is a cross-sectional view of a quantum dot layer of an exemplary semiconductor device implemented in one embodiment of the present invention.

FIG. 4 is a cross-sectional view of a radiation emitting diode including a quantum dot layer implemented in one embodiment of the present invention.

FIG. 5 is a cross-sectional view of a radiation emitting diode including a quantum dot layer implemented in one embodiment of the present invention.

FIG. 6 is a cross-sectional view of a radiation emitting diode including a quantum dot layer implemented in to one embodiment of the present invention.

FIG. 7 is a cross-sectional view of a laser diode including a quantum dot layer implemented in one embodiment of the present invention.

FIG. 8 shows a graphical representation of a single RED semiconductor device.

FIGS. 9 and 10 show the relative percentage of infrared energy transmitted through a 10 mil thick section of PET as a function of wavelength.

FIGS. 11a, 11b, and 11c show a typical ensemble of individual RED emitters packaged together into a RED heater element.

FIGS. 12a and 12b show the preferred deployment of RED heater elements within a blow molder.

FIG. 13 shows a preferred method for the thermal treatment of preforms as described by this invention.

FIGS. 14-16 show alternate methods for the thermal treatment of thermoplastic preforms according to this invention.

FIG. 17 shows RED heater elements being advantageously applied to a dynamically transported part.

FIG. 18 is a graph illustrating features of the present invention.

FIGS. 19(a)-19(c) illustrate an embodiment of the present invention.

FIGS. 20a-20c illustrate an embodiment of the present invention.

FIGS. 21a and 21b illustrate and embodiment of the present invention.

FIG. 22 illustrates an embodiment of the present invention.

FIGS. 23a-23c illustrate an embodiment of the present invention.

FIG. 24 illustrates an embodiment of the present invention.

FIG. 25 illustrates an embodiment of the present invention.

### DETAILED DESCRIPTION OF THE INVENTION

The benefits of providing wavelength specific irradiation can be illustrated by looking at a hypothetical radiant heating example. Assume that a material which is generally transparent to electromagnetic radiation from the visible range through the mid-infrared range requires process heating to support some manufacturing operation. Also assume that this generally transparent material has a narrow but significant molecular absorption band positioned between 3.0 and 3.25 micrometers. The example described above is representative of how the presently described embodiments might be most advantageously applied within industry. If the parameters of this particular process heating application dictated the use of radiant heating techniques, the current state-of-the-art would call for the use of quartz lamps operated at a filament temperature of approximately 3000° K. At this filament temperature, fundamental physical calculations yield the result that only approximately 2.1% of the total emitted radiant energy of a quartz lamp falls within the 3.0 to 3.25 micrometer band wherein advantageous energy absorption will occur. The ability to generate only wavelength-specific radiant energy output as described within this disclosure holds the promise of greatly improving the efficiency of various process heating applications.

The subject invention is directly related to a novel and new approach to be able to directly output substantial quantities of infrared radiation at selected wavelengths for the purpose of replacing such broadband type devices. Narrow band irradiation sources such as those described below and others that achieve narrow band irradiation objectives are most advantageously used.

Recent advances in semiconductor processing technology have resulted in the availability of direct electron-to-photon solid-state emitters that operate in the general mid-infrared range above 1 micrometer (1,000 nanometers). These solid state devices operate analogous to common light emitting diodes (LEDs), only they do not emit visible light but emit true, thermal IR energy at the longer mid-infrared wavelengths. In one form, these are an entirely new class of devices which utilize quantum dot technology that have broken through the barriers which have prevented useable, cost effective solid state devices from being produced which could function as direct electron to photon converters whose output is pseudo-monochromatic and in the mid-infrared wavelength band.

To distinguish this new class of devices from the conventional shorter wavelength devices (LEDs), these devices are more appropriately described as radiance or radiation emitting diodes (REDs). The devices have the property of emitting radiant electromagnetic energy in a tightly limited wavelength range. Furthermore, through proper semiconductor processing operations, REDs can be tuned to emit at specific wavelengths that are most advantageous to a particular radiant treatment application. REDs may take a variety of forms, including diode forms or laser diode forms, or, in some cases, laser forms. It should be understood that any type of device that achieves narrow band irradiation in desired bands or ranges that, for example, match the absorptive qualities of the target or target entities, may be used to implement the invention, and, for ease of reference herein, may be referred to as REDs.

In addition, innovations in RED technology related to the formation of a doped planar region in contact with an oppositely doped region formed as a randomly distributed array of small areas of material or quantum dots for generating photons in the targeted IR range and potentially beyond has evolved. This fabrication technique, or others such as the development of novel semiconductor compounds, adequately applied would yield suitable pseudo-monochromatic, solid-state mid-infrared emitters for the subject invention. Alternate semi-conductor technologies may also become available in both the mid-infrared as well as for long wavelength infrared that would be suitable building blocks with which to practice this invention.

Direct electron (or electric current)-to-photon conversions as contemplated within these described embodiments occur within a narrow wavelength range often referred to as pseudo-monochromatic, consistent with the intrinsic band-gap and quantum dot geometry of this fabricated diode emitter. It is anticipated that the half-power bandwidths of candidate RED emitters will fall somewhere within the 20-500 nanometer range. The narrow width of infrared emitters of this type should support a variety of wavelength-specific irradiation applications as identified within the content of this complete disclosure. One family of RED devices and the technology with which to make them are subject of a separate patent application, U.S. Application Ser. No. 60/628,330, filed on Nov. 16, 2004, entitled “Quantum Dot Semiconductor Device” and naming Samar Sinharoy and Dave Wilt as inventors (Attorney Docket No. ERI.P.US0002; Express Mail Label No. EL 726091609 US) (also filed as U.S. application Ser. No. 11/280,509 on Nov. 16, 2005), which application is incorporated herein by reference.

According to this “Quantum Dot Semiconductor Device” application, semiconductor devices are known in the art. They are employed in photovoltaic cells that convert electromagnetic radiation to electricity. These devices can also be employed as light emitting diodes (LEDs), which convert electrical energy into electromagnetic radiation (e.g., light). For most semiconductor applications, a desired bandgap (electron volts) or a desired wavelength (microns) is targeted, and the semiconductor is prepared in a manner such that it can meet that desired bandgap range or wavelength range.

The ability to achieve a particular wavelength of emission or electron volt of energy is not trivial. Indeed, the semiconductor is limited by the selection of particular materials, their energy gap, their lattice constant, and their inherent emission capabilities. One technique that has been employed to tailor the semiconductor device is to employ binary or tertiary compounds. By varying the compositional characteristics of the device, technologically useful devices have been engineered.

The design of the semiconductor device can also be manipulated to tailor the behavior of the device. In one example, quantum dots can be included within the semiconductor device. These dots are believed to quantum confine carriers and thereby alter the energy of photon emission compared to a bulk sample of the same semiconductor. For example, U.S. Pat. No. 6,507,042 teaches semiconductor devices including a quantum dot layer. Specifically, it teaches quantum dots of indium arsenide (InAs) that are deposited on a layer of indium gallium arsenide (InₓGa₁₋ₓAs). This patent discloses that the emission wavelength of the photons associated with the quantum dots can be controlled by controlling the amount of lattice mismatching between the quantum dots (i.e., InAs) and the layer onto which the dots are deposited (i.e., InₓGa₁₋ₓAs). This patent also discloses the fact that the lattice mismatching between an InₓGa₁₋ₓAs substrate and an InAs quantum dot can be controlled by altering the level of indium within the InₓGa₁₋ₓAs substrate. As the amount of indium within the InₓGa₁₋ₓAs substrate is increased, the degree of mismatching is decreased, and the wavelength associated with photon emission is increased (i.e., the energy gap is decreased). Indeed, this patent discloses that an increase in the amount of indium within the substrate from about 10% to about 20% can increase the wavelength of the associated photon from about 1.1 μm to about 1.3 μm.

While the technology disclosed in U.S. Pat. No. 6,507,042 may prove useful in providing devices that can emit or absorb photons having a wavelength of about 1.3 μm, the ability to increase the amount of indium within an InₓGa₁₋ₓAs substrate is limited. In other words, as the level of indium is increased above 20%, 30%, or even 40%, the degree of imperfections or defects within crystal structure become limiting. This is especially true where the InₓGa₁₋ₓAs substrate is deposited on a gallium arsenide (GaAs) substrate or wafer. Accordingly, devices that emit or absorb photons of longer wavelength (lower energy gap) cannot be achieved by employing the technology disclosed in U.S. Pat. No. 6,507,042.

Accordingly, inasmuch as it would be desirable to have semiconductor devices that emit or absorb photons of wavelength longer than 1.3 μm, there remains a need for a semiconductor device of this nature.

In general, a RED provides a semiconductor device comprising an InₓGa₁₋ₓAs layer, where x is a molar fraction of from about 0.64 to about 0.72 percent by weight indium, and quantum dots located on said InₓGa₁₋ₓAs layer, where the quantum dots comprise InAs or Al_{z}In_{z}As, where z is a molar fraction of less than about 5 percent by weight aluminum.

The present invention also includes a semiconductor device comprising a quantum dot comprising InAs or Al_{z}In_{z}As, where z is a molar fraction of less than about 5 percent by weight aluminum, and a cladding layer that contacts at least a portion of the quantum dot, where the lattice constant of the quantum dot and said cladding layer are mismatched by at least 1.8% and by less than 2.4%.

The semiconductor devices include a quantum dot layer including indium arsenide (InAs) or aluminum indium arsenide (Al_{z}In_{z}As where z is equal to or less than 0.05) quantum dots on an indium gallium arsenide (InₓGa₁₋ₓAs) layer, which may be referred to as an InₓGa₁₋ₓAs matrix cladding. The lattice constant of the dots and the InₓGa₁₋ₓAs matrix layer are mismatched. The lattice mismatch may be at least 1.8%, in other embodiments at least 1.9%, in other embodiments at least 2.0%, and in other embodiments at least 2.05%. Advantageously, the mismatch may be less than 3.2, in other embodiments less than 3.0%, in other embodiments less than 2.5%, and in other embodiments less than 2.2%. In one or more embodiments, the lattice constant of the InₓGa₁₋ₓAs matrix cladding is less than the lattice constant of the dots.

In those embodiments where the dots are located on an InₓGa₁₋ₓAs cladding matrix, the molar concentration of indium (i.e., x) within this cladding matrix layer may be from about 0.55 to about 0.80, optionally from about 0.65 to about 0.75, optionally from about 0.66 to about 0.72, and optionally from about 0.67 to about 0.70.

In one or more embodiments, the InₓGa₁₋ₓAs cladding matrix is located on an indium phosphorous arsenide (InP_{1-y}As_{y}) layer that is lattice matched to the InₓGa₁₋ₓAs cladding matrix. In one or more embodiments, the InP_{1-y}As_{y} layer onto which the InₓGa₁₋ₓAs cladding is deposited is a one of a plurality of graded (continuous or discrete) InP_{1-y}As_{y} layers that exist between the InₓGa₁₋ₓAs cladding and the substrate onto which the semiconductor is supported. In one or more embodiments, the substrate comprises an indium phosphide (InP) wafer. The semiconductor may also include one or more other layers, such as InₓGa₁₋ₓAs layers, positioned between the InₓGa₁₋ₓAs cladding and the substrate.

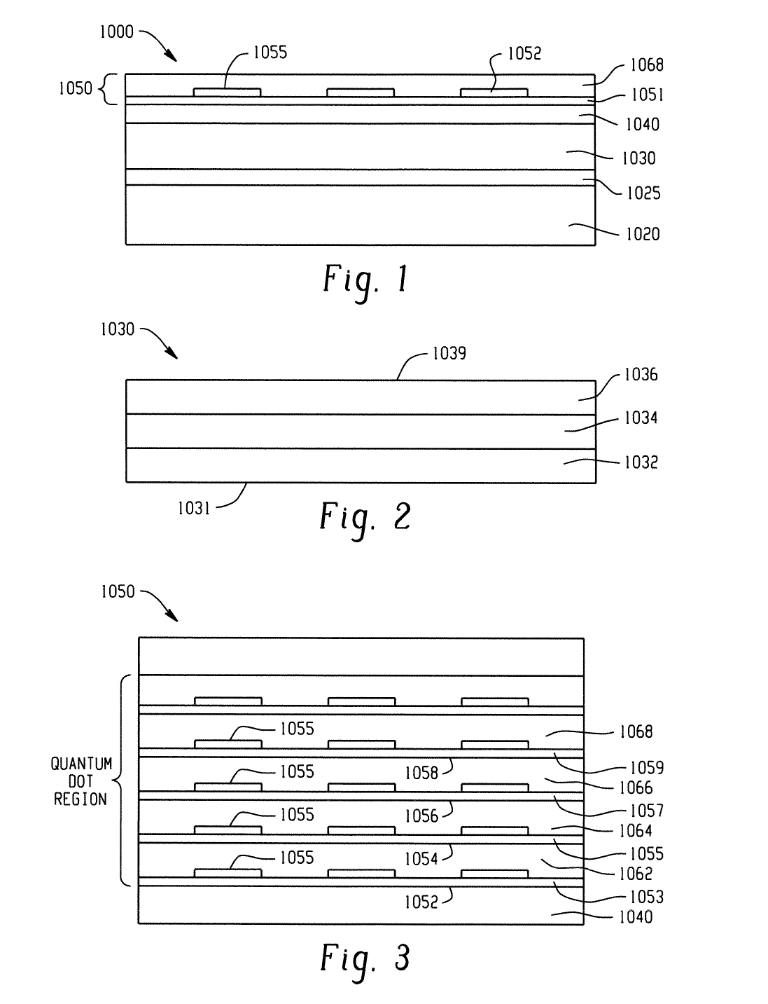

One embodiment is shown in FIG. 1. FIG. 1, as well as the other figures, are schematic representations and are not drawn to scale with respect to the thickness of each layer or component, or with respect to the relative thickness or dimension between each layer comparatively.

Device 1000 includes substrate 1020, optional conduction layer 1025, buffer structure 1030, cladding layer 1040, and dot layer 1050. As those skilled in the art appreciate, some semiconductor devices operate by converting electrical current to electromagnetic radiation or electromagnetic radiation to electrical current. The ability to control electromagnetic radiation or electrical current within these devices is known in the art. This disclosure does not necessarily alter these conventional designs, many of which are known in the art of manufacturing or designing semiconductor devices.

In one embodiment, substrate 1020 comprises indium phosphide (InP). The thickness of InP substrate 1020 may be greater than 250 microns, in other embodiments greater than 300 microns, and in other embodiments greater than 350 microns. Advantageously, the thickness may be less than 700 microns, in other embodiments less than 600 microns, and in other embodiments less than 500 microns.

In one or more embodiments, the semiconductor devices envisioned may optionally include an epitaxially grown layer of indium phosphide (InP). The thickness of this epitaxially grown indium phosphide layer may be from about 10 nm to about 1 micron.

In one embodiment, optional conduction layer 1025 comprises indium gallium arsenide (InₓGa₁₋ₓAs). The molar concentration of indium (i.e., x) within this layer may be from about 0.51 to about 0.55, optionally from about 0.52 to about 0.54, and optionally from about 0.53 to about 0.535. In one or more embodiments, conduction layer 1025 is lattice matched to the InP substrate.

Conduction layer 1025 may be doped to a given value and of an appropriate thickness in order to provide sufficient electrical conductivity for a given device. In one or more embodiments, the thickness may be from about 0.05 micron to about 2 microns, optionally from about 0.1 micron to about 1 micron.

In one or more embodiments, buffer layer 1030 comprises indium phosphorous arsenide (InP_{1-y}As_{y}). In certain embodiments, the buffer layer 1030 comprises at least two, optionally at least three, optionally at least four, and optionally at least five InP_{1-y}As_{y} layers, with the lattice constant of each layer increasing as the layers are positioned further from substrate 1020. For example, and as depicted in FIG. 2, buffer structure 1030 includes first buffer layer 1032, second buffer layer 1034, and third buffer layer 1036. The bottom layer surface 1031 of buffer structure 1030 is adjacent to substrate 1020, and the top planer surface 1039 of buffer structure 1030 is adjacent to barrier layer 1040. The lattice constant of second layer 1034 is greater than first layer 1032, and the lattice constant of third layer 1036 is greater than second layer 1034.

As those skilled in the art will appreciate, the lattice constant of the individual layers of buffer structure 1030 can be increased by altering the composition of the successive layers. In one or more embodiments, the concentration of arsenic in the InP_{1-y}As_{y} buffer layers is increased in each successive layer. For example, first buffer layer 1032 may include about 0.10 to about 0.18 molar fraction arsenic (i.e., y), second buffer layer 1034 may include about 0.22 to about 0.34 molar fraction arsenic, and third buffer layer 1036 may include about 0.34 to about 0.40 molar fraction arsenic.

In one or more embodiments, the increase in arsenic between adjacent buffer layers (e.g., between layer 1032 and layer 1034) is less than 0.17 molar fraction. It is believed that any defects formed between successive buffer layers, which may result due to the change in lattice constant resulting from the increase in the arsenic content, will not be deleterious to the semiconductor. Techniques for using critical composition grading in this fashion are known as described in U.S. Pat. No. 6,482,672, which is incorporated herein by reference.

In one or more embodiments, the thickness of first buffer layer 1032 may be from about 0.3 to about 1 micron. In one or more embodiments, the top buffer layer is generally thicker to ensure complete relaxation of the lattice structure.

In one or more embodiments, the individual buffer layer at or near the top 1039 of buffer structure 1030 (e.g., buffer layer 1036) is engineered to have a lattice constant that is from about 5.869 Å to about 5.960 Å, optionally from about 5.870 Å to about 5.932 Å.

In one or more embodiments, the individual buffer layer at or near the bottom 1031 of buffer structure 1030 (e.g., buffer layer 1032) is preferably engineered within the confines of the critical composition grading technique. In other words, inasmuch as a first buffer layer (e.g., buffer layer 1032) is deposited on and an InP wafer, the amount of arsenic present within the first buffer layer (e.g., layer 1032) is less than 17 mole fraction.

Cladding layer 1040 comprises InₓGa₁₋ₓAs. In one or more embodiments, this layer is preferably lattice matched to the in-plane lattice constant of the top buffer layer at or near the top 1039 of buffer structure 1030. The term lattice matched refers to successive layers that are characterized by a lattice constant that are within 500 parts per million (i.e., 0.005%) of one another.

In one or more embodiments, cladding layer 1040 may have a thickness that is from about 10 angstroms to about 5 microns, optionally from about 50 nm to about 1 micron, and optionally from about 100 nm to about 0.5 microns.

In one or more embodiments, quantum dot layer 1050 comprises indium arsenide (InAs). Layer 1050 preferably includes wetting layer 1051 and quantum dots 1052. The thickness of wetting layer 1051 may be one or two mono layers. In one embodiment, the thickness of dots 1052, measured from the bottom 1053 of layer 1050 and the peak of the dot 1055 may be from about 10 nm to about 200 nm, optionally from about 20 nm to about 100 nm, and optionally from about 30 nm to about 150 nm. Also, in one embodiment, the average diameter of dots 1052 may be greater than 10 nm, optionally greater than 40 nm, and optionally greater than 70 nm.

In one or more embodiments, quantum layer 1050 includes multiple layers of dots. For example, as shown in FIG. 3, quantum dot 1050 may include first dot layer 1052, second dot layer 1054, third dot layer 1056, and fourth dot layer 1058. Each layer comprises indium arsenide InAs, and includes wetting layers 1053, 1055, 1057, and 1059, respectively. Each dot layer likewise includes dots 1055. The characteristics of the each dot layer, including the wetting layer and the dots, are substantially similar although they need not be identical.

Disposed between each of dot layers 1052, 1054, 1056, and 1058, are intermediate cladding layers 1062, 1064, 1066, and 1068, respectively. These intermediate cladding layers comprise InₓGa₁₋ₓAs. In one or more embodiments, the InₓGa₁₋ₓAs intermediate cladding layers are substantially similar or identical to cladding layer 1040. In other words, the intermediate cladding layers are preferably lattice matched to barrier layer 1040, which is preferably lattice matched to top buffer layer 1036. In one or more embodiments, the thickness of intermediate layers 1062, 1064, 1066, and 1068 may be from about 3 nm to about 50 nm, optionally from about 5 nm to about 30 nm, and optionally from about 10 nm to about 20 nm.

As noted above, the various layers surrounding the quantum dot layer may be positively or negatively doped to manipulate current flow. Techniques for manipulating current flow within semiconductor devices is know in the art as described, for example, in U.S. Pat. Nos. 6,573,527, 6,482,672, and 6,507,042, which are incorporated herein by reference. For example, in one or more embodiments, regions or layers can be doped “p-type” by employing zinc, carbon, cadmium, beryllium, or magnesium. On the other hand, regions or layers can be doped “n-type” by employing silicon, sulfur, tellurium, selenium, germanium, or tin.

The semiconductor devices envisioned can be prepared by employing techniques that are known in the art. For example, in one or more embodiments, the various semiconductor layers can be prepared by employing organo-metallic vapor phase epitaxy (OMVPE). In one or more embodiments, the dot layer is prepared by employing a self-forming technique such as the Stranski-Krastanov mode (S-K mode). This technique is described in U.S. Pat. No. 6,507,042, which is incorporated herein by reference.

One embodiment of a radiation emitting diode (RED) including a quantum dot layer is shown in FIG. 4. RED 1100 includes base contact 1105, infrared reflector 1110, semi-insulating semiconductor substrate 1115, n-type lateral conduction layer (LCL) 1120, n-type buffer layer 1125, cladding layer 1130, quantum dot layer 1135, cladding layer 1140, p-type layer 1145, p-type layer 1150, and emitter contact 1155. Base contact 1105, infrared reflector 1110, semi-insulating semiconductor substrate 1115, n-type lateral conduction layer (LCL) 1120, n-type buffer layer 1125, cladding layer 1130, quantum dot layer 1135, and cladding layer 1140 are analogous to those semiconductor layers described above.

Base contact 1105 may include numerous highly conductive materials. Exemplary materials include gold, gold-zinc alloys (especially when adjacent to p-regions), gold-germanium alloy, or gold-nickel alloys, or chromium-gold (especially when adjacent to n-regions). The thickness of base contact 1105 may be from about 0.5 to about 2.0 microns. A thin layer of titanium or chromium may be used to increase the adhesion between the gold and the dielectric material.

Infrared reflector 1110 comprises a reflective material and optionally a dielectric material. For example, a silicon oxide can be employed as the dielectric material and gold can be deposited thereon as an infrared reflective material. The thickness of reflector 1110 may be form about 0.5 to about 2 microns.

Substrate 1115 comprises InP. The thickness of substrate 1115 may be from about 300 to about 600 microns.

Lateral conduction layer 1120 comprises InₓGa₁₋ₓAs that is lattice matched (i.e. within 500 ppm) to InP substrate 1115. Also, in one or more embodiments, layer 1120 is n-doped. The preferred dopant is silicon, and the preferred degree of doping concentration may be from about 1 to about 3 E19/cm³. The thickness of lateral conduction layer 1120 may be from about 0.5 to about 2.0 microns.

Buffer layer 1125 comprises three graded layers of InP_{1-y}As_{y} in a fashion consistent with that described above. Layer 1125 is preferably n-doped. The preferred dopant is silicon, and the doping density may be from about 0.1 to about 3 E 9/cm³.

Cladding layer 1130 comprises InₓGa₁₋ₓAs that is lattice matched to the in-plane lattice constant (i.e. within 500 ppm) of the top of buffer layer 1125 (i.e. the third grade or sub-layer thereof). In one or more embodiments, InₓGa₁₋ₓAs cladding layer 1130 comprises from about 0.60 to about 0.70 percent mole fraction indium. The thickness of cladding layer 1130 is about 0.1 to about 2 microns.

Quantum dot layer 1135 comprises InAs dots as described above with respect to the teachings of this invention. As with previous embodiments, the intermediate layers between each dot layer include InₓGa₁₋ₓAs cladding similar to cladding layer 1130 (i.e., lattice matched). In one or more embodiments, the amount of indium in one or more successive intermediate cladding layers may include less indium than cladding layer 1130 or a previous or lower intermediate layer.

Cladding layer 1140 comprises InₓGa₁₋ₓAs that is lattice matched (i.e. within 500 ppm) to the top of buffer layer 1125 (i.e. the third grade or sub-layer thereof).

Confinement layer 1145 comprises InP_{1-y}As_{y} that is lattice matched to InₓGa₁₋ₓAs layer 1140. Also, in one or more embodiments, layer 1145 is p-doped. The preferred dopant is zinc and the doping concentration may be from about 0.1 to about 4 E19/cm³. The thickness of confinement layer 1145 may be from about 20 nm to about 200 nm.

Contact layer 1150 comprises InₓGa₁₋ₓAs that is lattice matched to confinement layer 1145. Contact layer 1150 is preferably p-doped (e.g., doped with zinc). The doping concentration may be from about 1 to about 4 E19/cm³. The thickness of contact layer 1150 is from about 0.5 to about 2 microns. The contact layer 1150 may be removed from the entire surface except under layer 1155.

Emitter contact 1155 may include any highly conductive material. In one or more embodiments, the conductive material includes a gold/zinc alloy.

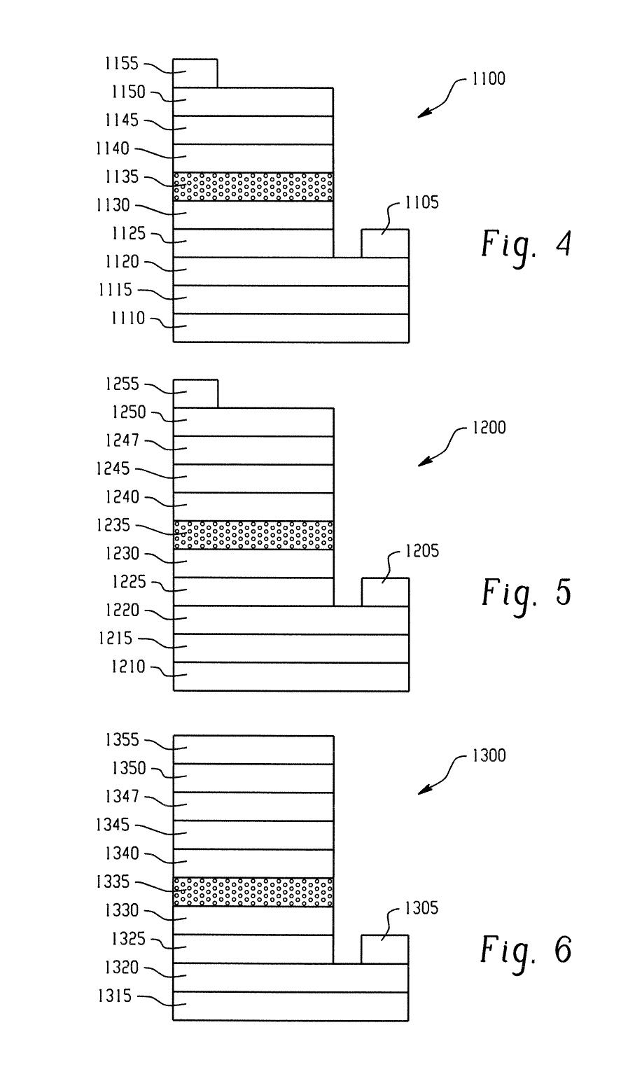

Another embodiment is shown in FIG. 5. Semiconductor device 1200 is configured as a radiation emitting diode with a tunnel junction within the p region. This design advantageously provides for lower resistance contacts and lower resistance current distribution. Many aspects of semiconductor 1200 are analogous to semiconductor 1100 shown in FIG. 4. For example, contact 1205 may be analogous to contact 1105, reflector 1210 may be analogous to reflector 1110, substrate 1215 may be analogous to substrate 1115, lateral conduction layer 1220 may be analogous to conduction layer 1120, buffer layer 1225 may be analogous to buffer layer 1125, cladding layer 1230 may be analogous to cladding layer 1130, dot layer 1235 may be analogous to dot layer 1135, cladding layer 1240 may be analogous to cladding layer 1140, and confinement layer 1245 may be analogous to confinement layer 1145.

Tunnel junction layer 1247 comprises InₓGa₁₋ₓAs that is lattice matched to confinement layer 1245. The thickness of tunnel junction layer 1247 is about 20 to about 50 nm. Tunnel junction layer 1247 is preferably p-doped (e.g., with zinc), and the doping concentration may be from about 1 to about 4 E19/cm³. Tunnel junction layer 1250 comprises InₓGa₁₋ₓAs that is lattice matched to tunnel junction 1247. The thickness of tunnel junction layer 1250 is from about 20 to about 5,000 nm. Tunnel junction layer 1250 is preferably n-doped (e.g., silicon), and the doping concentration is from about 1 to about 4 E19/cm³.

Emitter contact 1255 may include a variety of conductive materials, but preferably comprises those materials that are preferred for n-regions such as chromium-gold, gold-germanium alloys, or gold-nickel alloys.

Another embodiment of an RED is shown in FIG. 6. Semiconductor device 1300 is configured as a radiation emitting diode in a similar fashion to the RED shown in FIG. 5 except that electromagnetic radiation can be emitted through the substrate of the semiconductor device due at least in part to the absence of the base reflector (e.g., the absence of a reflector such as 1210 shown in FIG. 5). Also, the semiconductor device 1300 shown in FIG. 6 includes an emitter contact/infrared reflector 1355, which is a “full contact” covering the entire surface (or substantially all of the surface) of the device.

In all other respects, device 1300 is similar to device 1200. For example, contact 1305 may be analogous to contact 1205, substrate 1315 may be analogous to substrate 1215, lateral conduction layer 1320 may be analogous to conduction layer 1220, buffer layer 1325 may be analogous to buffer layer 1225, cladding layer 1330 may be analogous to cladding layer 1230, dot layer 1335 may be analogous to dot layer 1235, cladding layer 1340 may be analogous to cladding layer 1240, and confinement layer 1345 may be analogous to confinement layer 1245, tunnel junction layer 1347 is analogous to tunnel junction layer 1247, tunnel junction layer 1350 is analogous to tunnel junction layer 1250.

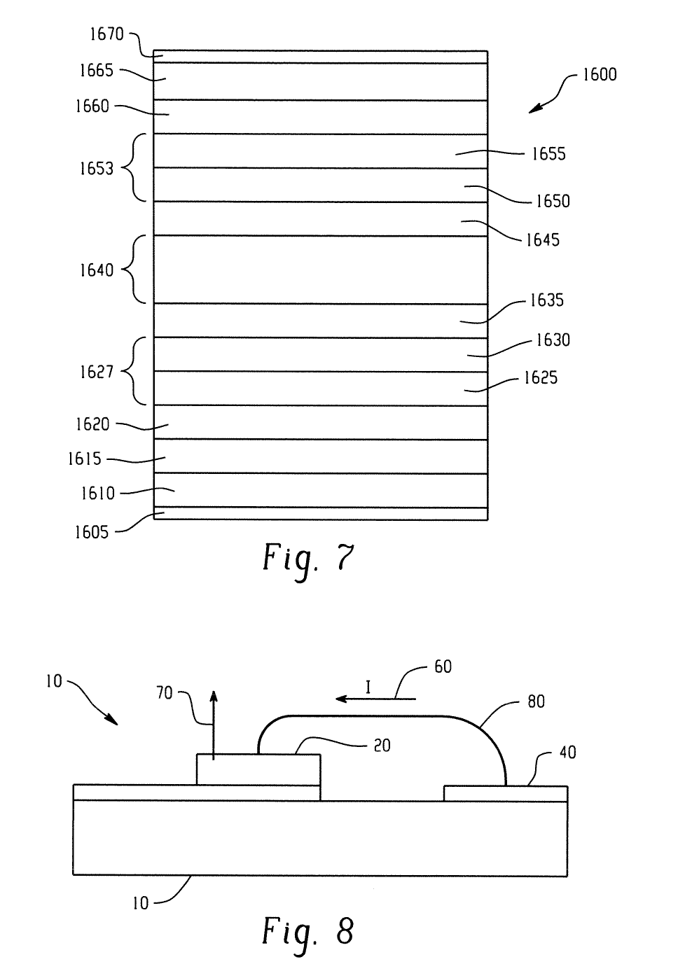

The semiconductor technology envisioned may also be employed in the manufacture of laser diodes. An exemplary laser is shown in FIG. 7. Laser 1600 includes contact 1605, which can comprise any conductive material such as gold-chromium alloys. The thickness of contact layer 1605 is from about 0.5 microns to about 2.0 microns.

Substrate 1610 comprises indium phosphide that is preferably n-doped at a concentration of about 5 to about 10 E18/cm³. The thickness of substrate 1610 is from about 250 to about 600 microns.

Optional epitaxial indium phosphide layer 1615 is preferably n-doped at a concentration of about 0.2 4 E19/cm³ to about 1 E19/cm³. The thickness of epitaxial layer 615 is from about 10 nm to about 500 nm.

Grated InP_{1-y}As_{y} layer 1620 is analogous to the grated InP_{1-y}As_{y} buffer shown in FIG. 2. Buffer 1620 is preferably n-doped at a concentration at about 1 to about 9 E18/cm³.

Layer 1625 and 1630 form wave guide 1627. Layer 1625 comprises indium gallium arsenide phosphide (In₁₋ₓGAₓAs_{z}P_{1-z}). Layer 1630 likewise comprises In₁₋ₓGAₓAs_{z}P_{1-z}. Both layers 1625 and 1630 are lattice matched to the top of layer 1620. In other words, layers 1625 and 1630 comprise about 0 to about 0.3 molar fraction gallium and 0 to about 0.8 molar fraction arsenic. Layer 1625 is about 0.5 to about 2 microns thick, and is n-doped at a concentration of about 1-9 E18/cm³. Layer 1630 is about 500 to about 1,500 nm, and is n-doped at a concentration of about 0.5 to 1 E18/cm³.

Confinement layer 1635, dot layer 1640, and confinement layer 1645 are similar to the dot and confinement layers described above with respect to the other embodiments. For example, confinement layer 1635 is analogous to confinement layer 1040 and dot layer 1640 is analogous to dot layer 1050 shown in FIG. 3. In one or more embodiments, the number of dot layers employed within the dot region of the laser device is in excess of 5 dot layers, optionally in excess of 7 dot layers, and optionally in excess of 9 dot layers (e.g., cycles). Confinement layers 1635 and 1645 may have a thickness from about 125 to about 500 nm and are lattice matched to the wave guide. Layers 1635, 1640, and 1645 are preferably non-doped (i.e., they are intrinsic).

Layers 1650 and 1655 form wave guide 1653. In a similar fashion to layers 1625 and 1630, layers 1650 and 1655 comprise In₁₋ₓGAₓAs_{z}P_{1-z} that is lattice matched to the top of buffer 1620. Layer 1650 is about 500 to about 1,500 nm p-doped at a concentration of about 0.5 to about 1 E18/cm³. Layer 655 is about 1 to about 2 microns thick and is p-doped at a concentration of about 1 to about 9 E18/cm³.

In one embodiment, layer 1660 is a buffer layer that is analogous to buffer layer 1620. That is, the molar fraction of arsenic decreases as each grade is further from the quantum dots. Layer 1660 is preferably p-doped at a concentration of 1-9 E18/cm³.

Layer 1665 comprises indium phosphide (InP). The thickness of layer 1665 is about 200 to about 500 nm thick and is preferably p-doped at a concentration of about 1 to about 4 E19/cm³.

Layer 1670 is a contact layer analogous to other contact layers described in previous embodiments.

In other embodiments, layers 1660, 1665, and 1670 can be analogous to other configurations described with respect to other embodiments. For example, these layers can be analogous to layers 1145, 1150, and 1155 shown in FIG. 4. Alternatively, layers analogous to 1245, 1247, 1250, and 1255 shown in FIG. 5 can be substituted for layers 1660, 1665, and 1670.

Various modifications and alterations that do not depart from the scope and spirit of these device embodiments will become apparent to those skilled in the art.

Of course, it should be appreciated that, in one form, the invention herein incorporates RED elements as described. However, it should be understood that various other device technologies may be employed. For example, experimental mid-IR LEDs operating in a range from 1.6 micrometers to 5.0 micrometers are known but are not commercial realities. In addition, various semiconductor lasers and laser diodes may be employed with suitable modifications. For example, laser diodes or other devices having extended life characteristics (e.g., greater than 10-15,000 hours of life) that produce wavelengths, e.g. in a narrow band that matched the absorptive characteristics of the target, in a range greater than approximately 1.2 microns may be used. In one form, such devices may be made from Indium phosphide, which has proven to have a usable life of 100,000 hours or more in relatively low power, data communications applications (such as telecommunications). The estimated life in high power applications should be similar if the devices are cooled properly. Of course, other enabling technologies may be developed for efficiently producing limited bandwidth irradiation in advantageous wavelengths. Again, for case of reference, all such devices may (at various times) be referred to as REDs herein.

In order to practice the invention for a particular application, it will usually require deploying many suitable devices in order to have adequate amplitude of irradiation. Again, in one form, these devices will be RED devices. In most heat applications of the invention, such devices will typically be deployed in some sort of high density x by y array or in multiple x by y arrays, some of which may take the form of a customized arrangement of individual RED devices. The arrays can range from single devices to more typically hundreds, thousands, or unlimited number arrays of devices depending on the types and sizes of devices used, the output required, and the wavelengths needed for a particular implementation of the invention. The RED devices will usually be mounted on circuit boards which have at least a heat dissipation capability, if not special heat removal accommodations. Often the RED devices will be mounted on such circuit boards in a very high density/close proximity deployment. It is possible to take advantage of recent innovations in die mounting and circuit board construction to maximize density where desirable for high-powered applications. For example, such techniques as used with flip chips are advantageous for such purposes. Although the efficiency of the RED devices is good for this unique class of diode device, the majority of the electrical energy input is converted directly into localized heat. This waste heat must be conducted away from the semi-conductor junction to prevent overheating and burning out the individual devices. For the highest density arrays, they may likely use flip-chip and chip-on-board packaging technology with active and/or passive cooling. Multiple circuit boards will often be used for practicality and positioning flexibility. The x by y arrays may also comprise a mix of RED devices which represent at least two different selected wavelengths of infrared radiation in a range from, for example, 1 micrometer to 5 micrometers.

For most applications, the RED devices will be deployed advantageously in variously sized arrays, some of which may be three dimensional or non-planar in nature for better irradiation of certain types of targets. This is true for at least the following reasons:
1. To provide sufficient output power by combining the output of the multiple devices.
2. To provide for enough ‘spread’ of output over a larger surface than a single device could properly irradiate.
3. To provide the functionality that the programmability of an array of RED devices can bring to an application.
4. To allow mixing into the array devices that are tuned to different specified wavelengths for many functional reasons described in this document.
5. To facilitate matching the ‘geometry’ of the output to the particular application requirement.
6. To facilitate matching the devices mounting location, radiating angles and economics to the application requirements.
7. To facilitate the synchronization of the output to a moving target or for other ‘output motion’.
8. To accommodate driving groups of devices with common control circuitry.
9. To accommodate multi-stage heating techniques.

Because of the typical end uses of diodes, they have been manufactured in a manner that minimizes cost by reducing the size of the junction. It therefore requires less semiconductor wafer area which is directly correlated to cost. The end use of RED devices will often require substantial radiated energy output in the form of more photons. It has been theorized that REDs could be manufactured with creative ways of forming a large photon producing footprint junction area. By so doing, it would be possible to produce RED devices capable of sustaining dramatically higher mid-infrared, radiant output. If such devices are available, then the absolute number of RED devices needed to practice this invention could be reduced. It would not necessarily be desirable or practical, however, given the high power outputs associated with the many applications of this invention, that the number of devices would be reduced to a single device. The invention can be practiced with a single device for lower powered applications, single wavelength applications, or, if the RED devices can be manufactured with sufficient output capability.

Similarly, it is possible to manufacture the RED device arrays as integrated circuits. In such an implementation the REDs would be arrayed within the confines of a single piece of silicon or other suitable substrate but with multiple junctions that function as the photon conversion irradiation sites on the chip. They could be similar to other integrated circuit packages which use ball grid arrays for electrical connectivity. Such device packages could then be used as the array, facilitating the desired electrical connectivity for connection to and control by the control system. Again, a design parameter is the control of the junction temperature which should not be allowed to reach approximately 100° to 105° C., with current chemistries, before damage begins to occur. It is anticipated that future chemistry compounds may have increased heat tolerance but heat must always be kept below the critical damage range of the device employed. They could further be deployed either on circuit boards individually or in multiples or they could be arrayed as a higher level array of devices as dictated by the application and the economics.

In designing the best configuration for deploying RED devices into irradiation arrays, regardless of the form factor of the devices, the designer must consider the whole range of variables. Some of the variables to be considered in view of the targeted application include packaging, ease of deployment, costs, electronic connectivity, control to programmability considerations, cooling, environment of deployment, power routing, power supply, string voltage, string geometry, irradiation requirements, safety and many others that one skilled in the appropriate arts will understand.

All raw materials used to manufacture products have associated with them particular absorption and transmission characteristics at various wavelengths within the electromagnetic spectrum. Each material also has characteristic infrared reflection and emission properties but we will not spend any time discussing these because the practicing of this invention is more driven by the absorption/transmission properties. The percent of absorption at any given wavelength can be measured and charted for any specific material. It can then be shown graphically over a wide range of wavelengths as will be explained and exampled in more detail later in this document. Because each type of material has characteristic absorption or transmission properties at different wavelengths, for best thermal process optimization it is very valuable to know these material properties. It should be recognized that if a certain material is highly transmissive in a certain range of wavelengths then it would be very inefficient to try to heat that material in that wavelength range. Conversely, if the material is too absorptive at a certain wavelength, then the application of radiant heating will result in surface heating of the material. For materials that are inefficient heat conductors, this is not usually an optimum way to heat evenly through the material.

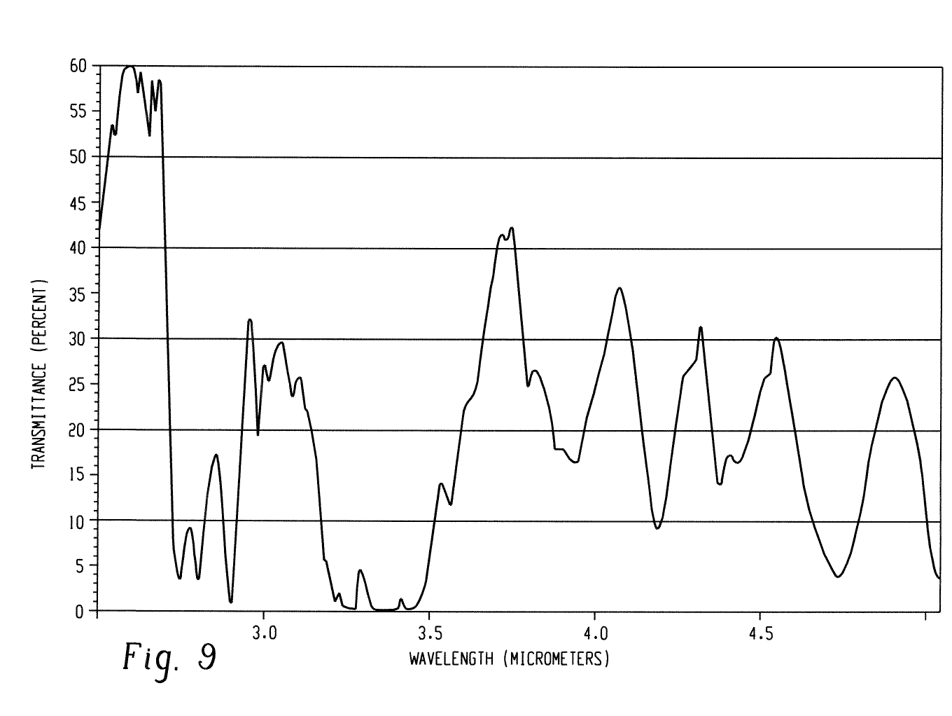

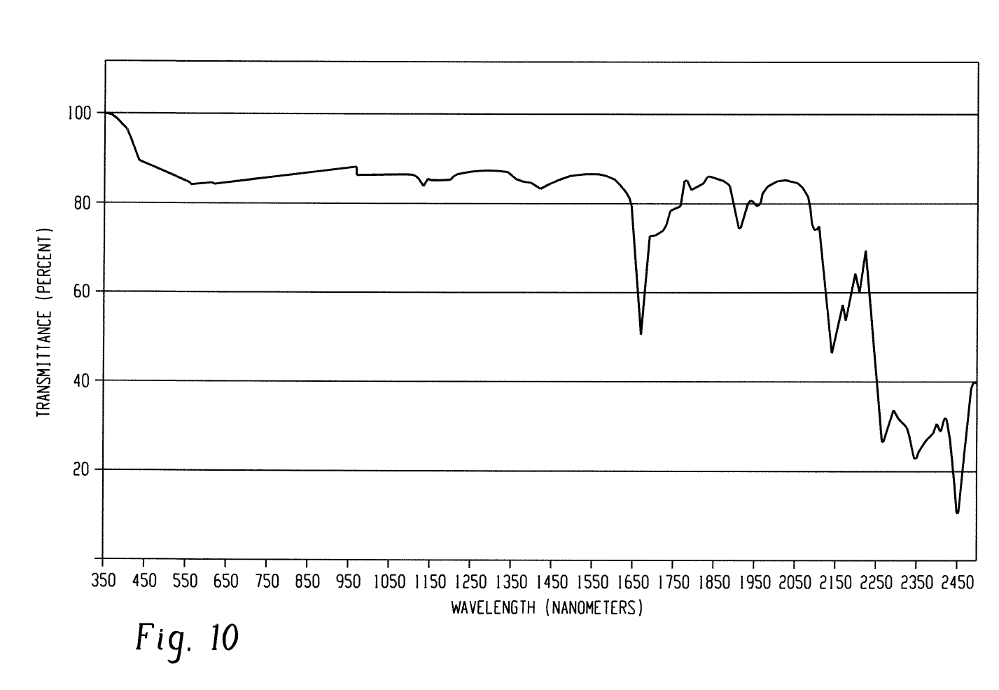

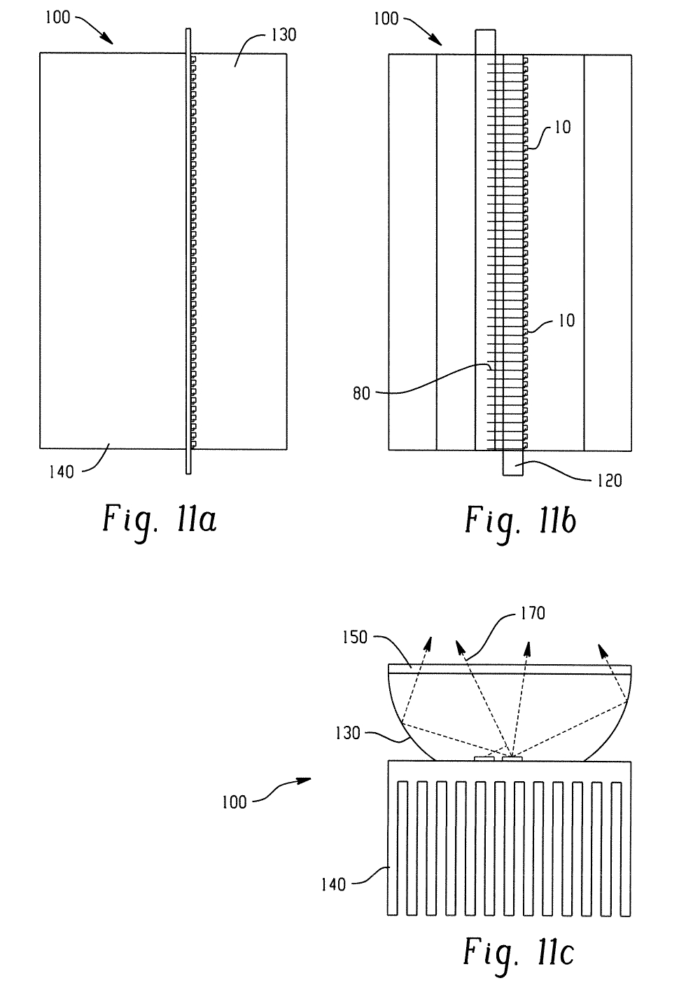

The fact that various materials have specific absorption or transmission characteristics at various wavelengths has been well known in the art for many years. Because, however, high-powered infrared sources were not available that could be specified at particular wavelengths, or combinations of wavelengths, it has not historically been possible to fully optimize many of the existing heating or processing operations. Since it was not practical to deliver specific wavelengths of infrared radiation to a product, many manufacturers are not aware of the wavelengths at which their particular product is most desirously heated or processed. However, the present invention utilizes narrow band irradiation sources to match the absorptive quality of the targets to be heated. So, for example, as will be illustrated below, absorptive ranges for PET (e.g. 1.5 micrometers to 2.5 micrometers) or absorptive bands (e.g. approximately 1.6 micrometers or others shown on FIGS. 9 and 10) may be advantageously used in the container industry. For PET preforms, in at least one form, it may be advantageous to use devices that can irradiate in a range, or narrow band, above 1.2 microns. As alluded to above, in a least one form, such devices (such as those formed using Indium phosphide) may also have extended usable life characteristics, which usable life may exceed 100,000 hours. A similar approach can be used when using other types of material such as PLA, a corn-based plastic resin.

This is illustrated this with an example in the plastics industry. Referring to FIGS. 9 and 10, by examining the transmission curve of Polyethylene terephthalate (PET resin material, as it is known in the industry), out of which plastic beverage containers are stretch blow molded, it can be observed that the PET material is highly absorptive in the long wavelength region and is highly transmissive in the visible and near-infrared wavelength regions. Its transmission varies dramatically between 1 micrometers and 5 micrometers. Its transmission not only varies dramatically in that range but it varies frequently and abruptly and often very substantially sometimes within 0.1 micrometers.

For example, at 2.9 micrometers PET has a very strong absorption. This means that if infrared radiation was introduced to PET at 2.9 micrometers, it would nearly all be absorbed right at the surface or outer skin of the material. If it were desirable to heat only the outer surface of the material, then this wavelength could be used. Since PET is a very poor conductor of heat (has a low coefficient of thermal conductivity) and since it is more desirable in stretch blow molding operations to heat the PET material deeply from within and evenly all the way through its volume, this is, in practice, a bad wavelength at which to heat PET properly.

Looking at another condition, at 1.0 micrometer (1000 nanometers) PET material is highly transmissive. This means that a high percentage of the radiation at this wavelength that impacts the surface of the PET, will be transmitted through the PET and will exit without imparting any preferential heating, hence be largely wasted. It is important to note that the transmission of electromagnetic energy decreases exponentially as a function of thickness for all dielectric materials, so the material thickness has a substantial impact on the choice for the optimal wavelength for a given material.

It should be understood that while PET thermoplastic material has been used here as an example, the principles hold true for a very wide range of different types of materials used in different industries and for different types of processes. As a very different example, a glue or adhesive lamination system is illustrative. For example, PEN (polyethylene naphthalate) or PLA (polylactic acid) are materials to which these principles may apply. In this example, suppose that the parent material that is to be glued is very transmissive at a chosen infrared wavelength. The heat-cured glue that is to be employed might be very absorptive at that same wavelength. By irradiating the glue/laminate sandwich at this specific advantageous wavelength, the process is further optimized because the glue, and not the adjacent parent material, is heated. By selectively choosing these wavelength interplays, optimum points are found within various widely diverse kinds of processing or heating applications within industry.

Historically, the ability to produce relatively high infrared radiation densities at specific wavelengths has simply not been available to industry. Therefore, since this type of heating or processing optimization has not been available, it has not been contemplated by most manufacturers. It is anticipated that the availability of such wavelength specific infrared radiant power will open entirely new methodologies and processes. The subject invention will make such new processes practical and will provide an implementation technology that has far reaching flexibility for a wide range of applications. While it is anticipated that the first utilizations of the subject invention will be in industry, it is also recognized that there will be many applications in commercial, medical, consumer, and other areas as well.

It is anticipated that the invention will be very useful as an alternative to broadband quartz infrared heating bulbs, or other conventional heating devices, that are currently in wide usage. Such quartz bulbs are used for a range of things including heating sheets of plastic material in preparation for thermo-forming operations. Not only can the subject invention be utilized as an alternative to the existing functionality of quartz infrared lamps or other conventional heating devices, but it can be envisaged to add substantial additional functionality.

The present invention, by contrast, can either generate radiant energy in a continuously energized or alternately a pulsed mode. Because the basic narrow band irradiation sources, such as REDs or other devices of the subject invention, have an extremely fast response time which measures in microseconds, it can be more energy efficient to turn the energy on when it is needed or when a target component is within the targeted area and then turn it off when the component is no longer in the targeted area.

The added functionality of being able to pulse energize the infrared source can lead to a considerable improvement in overall energy efficiency of many radiant heating applications. For example, by suitably modulating the energized time of either individual or arrays of the narrow band irradiation source, e.g. infrared radiation emitting devices (REDs), it is possible to track individual targets as they move past the large infrared array source. In other words, the infrared emitting devices that are nearest the target device would be the ones that would be energized. As the target component or region moves onward, the “energizing wave” could be passed down the array.

In the case of heating material which will be thermoformed, it could be desirable to apply more heat input into areas which will get more severely formed as compared to areas which will be more modestly formed or not formed at all. It is possible, by correctly designing the configuration of infrared emitter arrays, to not only not have all the devices energized simultaneously but it is possible to energize them very strategically to correspond to the shape of the area to be heated. For continuously moving production lines, for example, it might be most desirable to program a specially shaped area of desired heat profile that can be programmably moved in synchronous motion with the target region to be heated. Consider a picture frame shaped area requiring heating as shown in FIG. 17. In this case, it would be possible to have a similar picture frame shaped array of devices (402) at desired radiant intensity that would programmably move down the array, synchronized with the movement of the target thermoforming sheet (401). By using an encoder to track the movement of a product such as the (401) thermoforming sheet, well known electronics synchronization techniques can be used to turn on the right devices at the desired intensity according to a programmable controller or computer's instructions. The devices within the arrays could be turned on by the control system for their desired output intensity in either a “continuous” mode or a “pulsed” mode. Either mode could modulate the intensity as a function of time to the most desirable output condition. This control can be of groups of devices or down to individual RED devices. For a particular application, there may not be a need, to have granular control down to the individual RED devices. In these instances the RED devices can be wired in strings of most desired geometry. These strings or groups of strings may then be programmably controlled as the application requirements dictate. Practicality will sometimes dictate that the narrow band irradiation, or RED, devices are driven in groups or strings to facilitate voltages that are most convenient and to reduce the cost of individual device control.

The strings or arrays of REDs may be controlled by simply supplying current in an open loop configuration or more sophisticated control may be employed. The fact intensive evaluation of any specific application will dictate the amount and level of infrared radiant control that is appropriate. To the extent that complex or precise control is dictated, the control circuitry could continuously monitor and modulate the input current, voltage, or the specific output. The monitoring for most desirable radiant output or result could be implemented by directly measuring the output of the infrared array or, alternatively, some parameter associated with the target object of the infrared radiation. This could be performed by a continuum of different technologies from incorporating simple thermocouples or pyrometers up to much more sophisticated technologies that could take the form of, for example, infrared cameras. One skilled in the art will be able to recommend a particular closed loop monitoring technique that is economically sensible and justifiable for a particular application of the invention.

Both direct and indirect methods of monitoring can be incorporated. For example, if a particular material is being heated for the purpose of reaching a formable temperature range, it may be desirable to measure the force needed to form the material and use that data as at least a portion of the feedback for modulation of the infrared radiation arrays. Many other direct or indirect feedback means are possible to facilitate optimization and control of the output of the subject invention.

It should be clearly understood that the shapes, intensities, and energizing time of the present invention radiant heat source, as described herein, is highly programmable and lends itself to a very high level of programmable customization. Often in industry, custom shapes or configurations of heat sources are designed and built for a specific component to direct the heating to the correct locations on the component. With the flexible programmability of the subject invention it is possible for a single programmable heating panel to serve as a flexible replacement to an almost infinite number of custom-built panels. Industry is replete with a wide variety of infrared ovens and processing systems. Such ovens are used for curing paints, coatings, slurries of various sorts and types, and many other purposes. They also can be used in a wide variety of different lamination lines for heat fusing materials together or for curing glues, adhesives, surface treatments, coatings, or various layers that might be added to the lamination ‘sandwich’.

Other ovens may be used for a wide variety of drying applications. For example, in the two-piece beverage can industry it is common to spray a coating into the interior of the beverage can and then transport them continuously by conveyor “in mass” through a long curing oven. The uncured interior coating has the appearance of white paint upon application but after curing becomes nearly clear. In these various drying and curing applications with the current invention, it would be possible to choose a wavelength or combination of wavelengths that are the most readily and appropriately absorbed by the material that needs to be dried, treated, or cured. In some applications the wavelengths that are not present may be more important to an improved process than the ones that are present. The undesirable wavelengths may adversely affect the materials by drying, heating, changing grain structure or many other deleterious results which in a more optimum process could be avoided with the subject invention.

Often it is desirable to raise the temperature of a target material to be cured or dried without substantially affecting the substrate or parent material. It may well be that the parent material can be damaged by such processing. It is more desirable to not induce heat into it while still inducing heat into the target material. The subject invention facilitates this type of selective heating.

To review another application area for the invention, the medical industry has been experimenting with a wide range of visible light and near-infrared radiant treatments. It has been theorized that certain wavelengths of electromagnetic energy stimulate and promote healing. It has also been postulated that irradiation with certain wavelengths can stimulate the production of enzymes, hormones, antibodies, and other chemicals within the body as well as to stimulate activity in sluggish organs. It is beyond the scope of this patent to examine any of the specific details or treatment methodologies or the merit of such postulations. The subject invention however, can provide a solid state, wavelength selectable, and programmable mid-infrared radiation source that can facilitate a wide range of such medical treatment modalities.

It is historically true however that the medical industry has not had a practical methodology for producing high-powered, wavelength specific irradiation in the mid-IR wavelength bands. The present invention would allow for such narrow band wavelength specific infrared irradiation and it could do so in a slim, light weight, safe and convenient form factor that would be easily used for medical applications.

For medical treatment there are some very important advantages to being able to select the specific wavelength or combination of wavelengths that are used for irradiation. Just as in industrial manufacturing materials, organic materials also have characteristic transmission/absorption spectral-curves. Animal, plant, or human tissue exhibits specific absorption/transmissive windows which can be exploited to great advantage.

A very high percentage of the human body is composed elementally of water, therefore it is likely that the transmission/absorption curves for water are a good starting point for a rough approximation for much human tissue. Through extensive research it is possible to develop precise curves for all types of tissue in humans, animals, and plants. It is also possible to develop the relationship between various kinds of healing or stimulation that might be sought from organs or tissue and relate that to the transmission/absorption curves. By carefully selecting the wavelength or combination of wavelengths, it would be possible to develop treatment regimens which could have a positive effect with a wide range of maladies and ailments.

Some tissues or organs that it would be desirable to treat are very near the surface while others lie deep within the body. Due to the absorption characteristics of human tissue, it might not be possible to reach such deep areas with non-invasive techniques. It may be necessary to use some form of invasive technique in order to get the irradiation sources near the target tissue. It is possible to design the irradiation arrays of the present invention so that they are of the appropriate size and/or shape to be used in a wide range of invasive or non-invasive treatments. While the treatment techniques, modalities and configurations are beyond the scope of this discussion; the invention is the first of its kind available to make solid state, wavelength selective irradiation available in the middle-infrared wavelength bands. It can be configured for a wide range of modalities and treatment types. Due to its highly flexible form factor and programmable nature it is capable of being configured for a particular body size and weight to produce the appropriate angles, intensities, and wavelengths for custom treatment.

Infrared radiation is being utilized for an increasing number of medical applications from hemorrhoid treatments to dermatology. One example of infrared treatment that is currently performed with broadband infrared sources is called infrared coagulation treatment. Additionally, diabetic peripheral neuropathy is sometimes treated with infrared lamp treatments. Tennis elbow and other similar ailments are often currently treated with broadband infrared lamps as well. The incorporation of the present invention's ability to generate specific wavelengths of radiation as well as its ability to generate pulsed irradiation may provide substantial improvement in these treatments. It also may provide for better patient toleration and comfort. The invention also facilitates manufacturing a medical device that could be powered with inherently safe voltages.

The pulsing of the irradiation energy may prove to be a key aspect associated with many medical treatment applications. Continuous irradiation may cause tissue overheating while a pulsed irradiation may prove to provide enough stimulation without the deleterious effect of overheating, discomfort, or tissue damage. The very fact that the devices/arrays can be pulsed at extremely high rates with turn-on times measured in microseconds or faster provides another useful property. It is anticipated that very high intensity pulses of radiation may be tolerated without damage to the arrays if they are activated for very short duty cycles, since the semi-conductor junction overheat would not have time to occur with such short pulse times. This would allow greater summed instantaneous intensity which could facilitate penetration through more tissue.

The frequency at which the pulsing occurs may also prove to be important. It is known within the literature that certain frequencies of irradiation to humans can have healing or, alternatively, deleterious effects. For example, certain amplitude modulation frequencies or combinations of frequencies of visible light can cause humans to become nauseous and yet other amplitude modulation frequencies or combinations of frequencies can cause epileptic seizures. As further medical research is done it may indeed determine that the pulsing frequency, waveform shape, or combination of frequencies along with the selected wavelength or combination of wavelengths have a very substantial effect on the success of various radiation treatments. It is very likely that many of the treatment modalities which will utilize this invention are not yet understood nor realized since the subject invention has not been available to researchers or practitioners.

Another application for the subject invention is in the preparation processing, or staging of food. Certainly a very wide range of different types of ovens and heating systems have been used in the preparation of food throughout human history. Since most of them are well known, it is beyond the scope of this patent application to describe the full range of such ovens and heating systems. With the notable exception of microwave cooking which utilizes non-infrared/non-thermal source cooking technology, virtually all other cooking technologies utilize broadband heating sources of various types. The infrared heating sources and elements that are used in such ovens are broad-band sources. They do not have the ability to produce specific wavelengths of infrared energy that might be most advantageous to the particular cooking situation or the product being cooked.

As was discussed earlier with other materials, plant and animal products have specific absorption spectral curves. These specific absorption curves relate how absorptive or transmissive a particular food product is at specific wavelengths. By selecting a particular wavelength or a few carefully selected wavelengths at which to irradiate the subject food it is possible to modify or optimize the desired cooking characteristics. The most efficient use of radiated energy can reduce the cost of heating or cooking.

For example, if it is most desirous to heat or brown the outer surface of a particular food product, the subject invention would allow for the selection of a wavelength at which that particular food product is highly absorptive. The result would be that when irradiated at the chosen wavelength the infrared energy would all be absorbed very close to the surface, thus causing the desired heating and/or browning action to take place right at the surface. Conversely, if it is desired not to overheat the surface but rather to cook the food from very deeply within it, then it is possible to choose a wavelength or combination of selected wavelengths at which the particular food is much more transmissive so that the desired cooking result can be achieved. Thus the radiant energy will be absorbed progressively as it penetrates to the desired depth.

It is important to note that for electromagnetic waves traveling through a non-metallic material, the intensity of this wave I(t) decreases as a function of travel distance t as described by the following equation:

I(t)=Iₒ(e^{-αt})

In this equation, Iₒ is the initial intensity of the beam and α is the specific absorption coefficient for the material. As time t increases, the intensity of the beam undergoes exponential decay which is caused by radiant energy within the original beam being absorbed by the host material. For this reason, the use of infrared radiation heating to achieve optimum cooking results entails a complex interaction between the thickness of the food items, the applied infrared radiant intensity, the irradiation wavelength, and the material absorption coefficient(s).

By mixing RED elements that irradiate at different wavelengths, it is possible to further optimize a cooking result. Within such a multi-wavelength array, one element type would be chosen at a wavelength wherein the absorption of radiant energy is low, thus allowing deep-heat penetration to occur. A second element type would be chosen wherein the absorption of radiant energy is high thus facilitating surface heating to occur. Completing the array, a third RED element type could be conceived to be chosen at a wavelength intermediate to these two extremes in absorption. By controlling the relative radiant output level of the 3 types of RED emitters contained in such an array, it would be possible to optimize the important properties of prepared food items.

By connecting color, temperature, and potentially visual sensors to the control system it is possible to close the loop and further optimize the desired cooking results. Under such circumstances, it may be possible to check the exact parameter which might be in question and allow the control system to respond by sending irradiation at the appropriate wavelength, intensity, and direction that would be most desirable. By utilizing and integrating a vision sensor, it would be possible to actually view the locations and sizes of the food products that are to be cooked and then optimize the ovens' output accordingly as has been described above. When used in combination with a moisture sensor, it would be possible to respond with the combination that would maintain the desired moisture content. It is, therefore, possible to understand how the subject invention, in combination with the appropriate sensors, and controller “intelligence” can truly facilitate the smart oven of the future. It is, of course, possible to combine the present invention with conventional cooking technologies, including convection ovens and microwave oven capability to get the best blend of each of these technology offerings. The smart control system could be designed to best optimize both the present invention technology in combination with the conventional cooking technologies.

It is also possible, by selecting wavelengths that would be absorbed by one food and not as highly absorbed by a second food, to be very selective as to the amount of heating that takes place in a mixed plate of food. Thus it can be understood that by changing the combinations and permutations and intensities of various wavelengths that are selectable one could achieve a wide range of specifically engineered cooking results.

With any of the applications of the subject invention, it is possible to use various lensing or beam guiding devices to achieve the desired directionality of the irradiation energy. This can take the form of a range of different implementations—from individually lensed RED devices to micro lens arrays mounted proximate to the devices. The chosen beam guiding devices must be chosen appropriately to function at the wavelength of radiation that is being guided or directed. By utilizing well understood techniques for diffraction, refraction, and reflection, it is possible to direct energy from different portions of an array of RED devices in desired directions. By programmably controlling the particular devices that are turned on, and by modulating their intensities, it is possible to achieve a wide range of irradiation selectivity. By choosing steady state or pulsing mode and by further programming which devices are pulsed at what time, it is possible to raise the functionality even further.

Though this disclosure discusses the application of radiant energy primarily within the 1.0 to 3.5 micrometers range, it should be obvious to anyone skilled in the art that similar material heating effects can be achieved at other operational wavelengths, including longer wavelengths in the infrared or shorter wavelengths down through the visible region. The spirit of the disclosed invention includes the application of direct electron-to-photon solid-state emitters for the purposes of radiant heating wherein the emitters are conceivably operational from the visible through the far infrared. It may be desirable for certain types of applications, to combine other wavelength selectable devices into the invention which irradiate at other wavelengths outside the mid-infrared range.

FIG. 8 gives a graphical indication of a single RED component 10. The RED 10 comprises a stack 20. The stack 20 may take a variety of configurations, such as the stacks of semiconductor layers and the like illustrated in connection with FIGS. 1-7. In at least one form, the contact 40 (corresponding, for example, to contacts 1105, 1205 and 1305) of the RED 10 is made to the stack 20 through wire 80. When a current 60 is made to flow through the bonding wire 80 and the stack 20, photons 70 are emitted that possess a characteristic energy or wavelength consistent with the configuration of the stack 20.

Because many of the semi-conductor lessons learned in manufacturing LEDs may apply to REDs, it is useful to mention a parallel that may help the evolution of the new RED devices. Drastic improvements in the energy conversion efficiency (optical energy out/electrical energy in) of LEDs have occurred over the years dating to their introduction into the general marketplace. Energy conversion efficiencies above 10% have been achieved in commercially available LEDs that operate in the visible light and near IR portion of the spectrum. This invention contemplates the use of the new REDs operating somewhere within the 1 micrometer to 3.5 micrometer range as the primary infrared heating elements within various heating systems. This application describes a specific implementation in blow molding systems.

FIGS. 9 and 10 show the relative percentage of IR energy transmitted within a 10 mil thick section of PET as a function of wavelength. Within the quartz transmission range (up to 3.5 micrometer), the presence of strong absorption bands (wavelength bands of substantial or no transmission) are evident at several wavelengths including approximately 1.6 micrometer, 1.9 micrometer, 2.1 micrometer, 2.3 micrometer, 2.4 micrometer, 2.8 micrometer, and 3.4 micrometer. The basic concept associated with the subject invention is the use of RED elements designed and chosen to operate at a selected wavelength(s) within the 1 micrometer to 3.5 micrometer range as the fundamental heating elements within, for example, the thermal conditioning section of blow molding machines.

It should be appreciated that the method of delivering the energy, and the choice of wavelength(s) can be varied, in accordance with the needs of the application. In one form, the selected narrow wavelength range may be specifically tuned to the heating requirements of the material from which the particular target component (or target entity) is manufactured. Although it is theoretically possible to manufacture the narrow band irradiation devices such as diodes to monochromatic or near-monochromatic wavelength specificity, it is not practical to manufacture high output devices to be that narrow. Often, if the wavelength is centered in the absorption band correctly, plus or minus 14 or even 50 nanometers may be just fine. Some unusual applications, because of the narrowness or proximity of the absorption bands, may need to have a very narrow wavelength tolerance. The selected wavelengths chosen for use may be anywhere in the range from 1.0 to 5.0 microns, or may, more practically for PET as an example, be selected from the narrower range of 1.5 to 3.5 microns. Or, an example range of 1.2 microns or greater may be desired. Since diode or solid state devices can be manufactured that are more “wall-plug efficient” at shorter wavelengths, the most useful waveband ranges will be chosen at the shorter end of the range, if possible. The absorption rate characteristics of the material at the different wavelengths is a factor. If more than one absorber is involved, a “door and window” evaluation may be appropriate if, for example, one material is to be heated but not the other. One will need to determine if wavelengths can be chosen such that one material is a poor absorber while, at that same wavelength, the other is a strong absorber. These interplays are a valuable aspect of the present invention. By paying close attention to the absorptions and/or the interplays, system optimization can be achieved. The absorption band for a particular material may be selected based on, or to optimize, desired depth of heating, location of heating, speed of heating or thickness to be heated. In addition, the laser diodes (or other devices) contemplated herein may be used to pump other oscillating elements to achieve desired wavelengths.

FIGS. 11a, 11b, and 11c show an example ensemble of individual RED emitters 10 packaged together into a suitable RED heater element 100. In this embodiment of the invention, the REDs 10 are physically mounted so that N-doped regions are directly attached to a cathode bus 120. The cathode bus 120 is ideally fabricated out of a material such as copper, or gold, which is both a good conductor of electricity as well as heat. The corresponding regions of the REDs 10 are connected via bond wires 80 to the anode bus 110. Ideally, the anode bus would have the same thermal and electrical properties as the cathode bus. Input voltage is externally generated across the 2 bus bars causing a current (I) to flow within the REDs 10 resulting in the emission of IR photons or radiant energy, such as that shown at 170. A reflector 130 is used in the preferred embodiment to direct the radiant energy into a preferred direction away from the RED heater element 100. The small physical extent of the REDs 10 make it possible to more easily direct the radiant energy 170 that is emitted into a preferred direction. This statement being comparatively applied to the case of a much larger coiled filament; such a relationship between the physical size of an emitter and the ability to direct the resultant radiant flux using traditional lensing means being well known in the art.

A heat sink 140 is used to conduct waste heat generated in the process of creating IR radiant energy 170 away from the RED heater element 100. The heat sink 140 could be implemented using various means known within industry. These means include passive heat sinking, active heat sinking using convection air cooling, and active heat sinking using water or liquid cooling. The liquid cooling through, for example, a liquid jacket has the advantage of being able to conduct away the substantial amount of heat that is generated from the quantity of electrical energy that was not converted to radiant photons. Through the liquid media, this heat can be conducted to an outdoor location or to another area where heat is needed. If the heat is conducted out of the factory or device or to another location then air conditioning/cooling energy could be substantially reduced or used in a different way.

Additionally, a bulb 150 is optimally used in this embodiment of the invention. The primary function of the bulb 150 as applied here is to protect the REDs 10 and bonding wires 80 from being damaged. The bulb 150 is preferably constructed out of quartz due to its transmission range that extends from the visible through 3.5 micrometer. However, other optical materials including glass having a transmission range extending beyond the wavelength of operation of the REDs 10 could also be used.

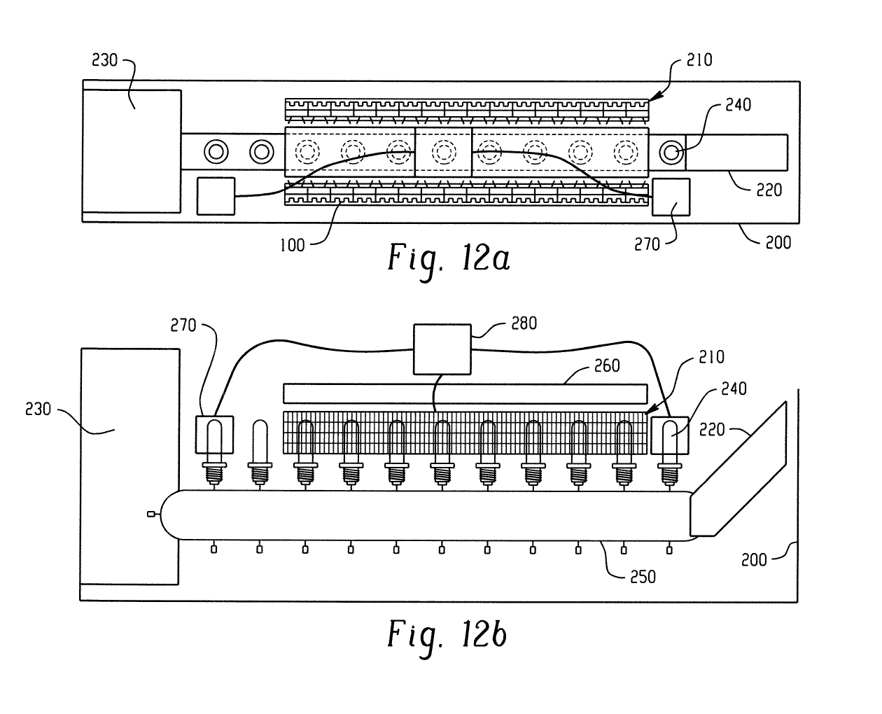

One deployment of the RED heater element 100, within a blow molder, is depicted in FIGS. 12a and 12b. In this system, preforms 240 enter into a thermal monitoring and conditioning system 210 via a transfer system 220. The preforms 240 could come into the thermal monitoring and control system 210 at room temperature, having been previously injection molded at some earlier time. Or, alternatively, the preforms 240 could come directly from an injection molding process as is done in single-stage injection molding/blow molding systems. Alternatively, the preforms could be made by one of several other processes. Whatever the form and timing of preform manufacturing, entering in this fashion, the preforms 240 would have varying amounts of latent heat contained within them.

Once presented by the transfer system 220, the preforms 240 are transported through the thermal monitoring and control system 210 via a conveyor 250, such conveyors being well known in industry. As the preforms 240 travel through the thermal monitoring and control system 210, they are subjected to radiant IR energy 170 emitted by a series of RED heater elements 100. The IR energy 170 emitted by these RED heater elements 100 is directly absorbed by the preforms 240 in preparation of entering the blowing system 230. It should be appreciated that the energy may be continuous or pulsed, as a function of the supply or drive current and/or other design objectives. The control system, such control system 280, in one form, controls this functionality. As an option, the control system is operative to pulse the system at electrical current levels that are substantially greater than recommended steady state current levels to achieve higher momentary emitted intensity in pulsed operation and respond to an input signal from an associated sensor capability to determine a timing of the pulsed operation.

As noted above, the arrays of narrow band irradiation heater elements may be arranged such that elements of different wavelengths can be implemented within the system. In a more specific example, elements of varying wavelengths can be used to accommodate preforms having multiple layers. Bottles having multiple layers are used for a variety of different applications, e.g. to provide oxygen, CO2, or ultraviolet light blocking, etc. Each separate layer may be of different material or have coatings which differentiate one layer from another layer. As a consequence, various layers within a preform may each have different absorptive qualities. That being the case, the arrays could be arranged and implemented so that narrow band irradiation elements of one wavelength emit radiation and heat a first layer of a multilayer preform, while narrow band irradiation of a second array emit radiation and heat a second layer of a multilayer preform. Of course, it should be appreciated that this may be accomplished in a variety of manners. For example, the layers can be heated simultaneously or sequentially. Also, the layers may be heated in subsections of the preforms, sequentially or simultaneously. In still a further alternative, the layers may be heated at distinct and separate times within the process. It should be understood that this type of arrangement may also be applied where a layer of material has distinct absorption peaks that are sought to be used in a process of heating, as opposed to distinct layers of material.

In the preferred embodiment of a blow molder operating using the method and means described by this invention, a convection cooling system 260 is also preferably deployed. This system removes waste heat from the air and mechanics that are in proximity to the preforms 240 under process. A conduction cooling device may also be employed to do so. Heating of preforms by convection and/or conduction is known in the art to be deleterious to the overall thermal conditioning process. This is because PET is a very poor thermal conductor and heating the outer periphery of the preform results in uneven through heating, with too cool a center and a too warm outer skin.

Also contained within the preferred system embodiment are temperature sensors 270 (which may take the form of an intelligent sensor or camera that is capable of monitoring a target in at least one aspect beyond that which a single point temperature measurement sensor is capable) and a temperature control system 280. These aspects of the preferred blow molder design are particularly applicable to the attributes of a one-stage blow molding system. In a one-stage blow molding system, the preforms 240 enter into the thermal monitoring and conditioning system 210 containing latent heat energy obtained during the injection molding stage. By monitoring the temperature and thus the heat content of the incoming preforms 240 (or specific subsections of such performs), it is possible for a temperature monitoring and control system 280 to generate preform-specific (or subsection specific) heating requirements and then communicate these requirements in the form of drive signals to the individual narrow band irradiation, or RED, heater elements 100. The solid-state nature and associated fast response times of narrow band irradiation, or RED, emitters 10 make them particularly suited to allow the electrical supply current or on-time to be modulated as a function of time or preform movement. Also, subsections of the RED array may be controlled, as will be appreciated.

The temperature control system 280 used to enact such output control could be implemented as an industrial PC as custom embedded logic or as or an industrial programmable logic controller (PLC), the nature and operation all three are well known within industry. The control system, such as that shown as 280, may be configured a variety of ways to meet the objectives herein. However, as some examples, the system may control on/off status, electrical current flow and locations of activated devices for each wavelength in an RED array.

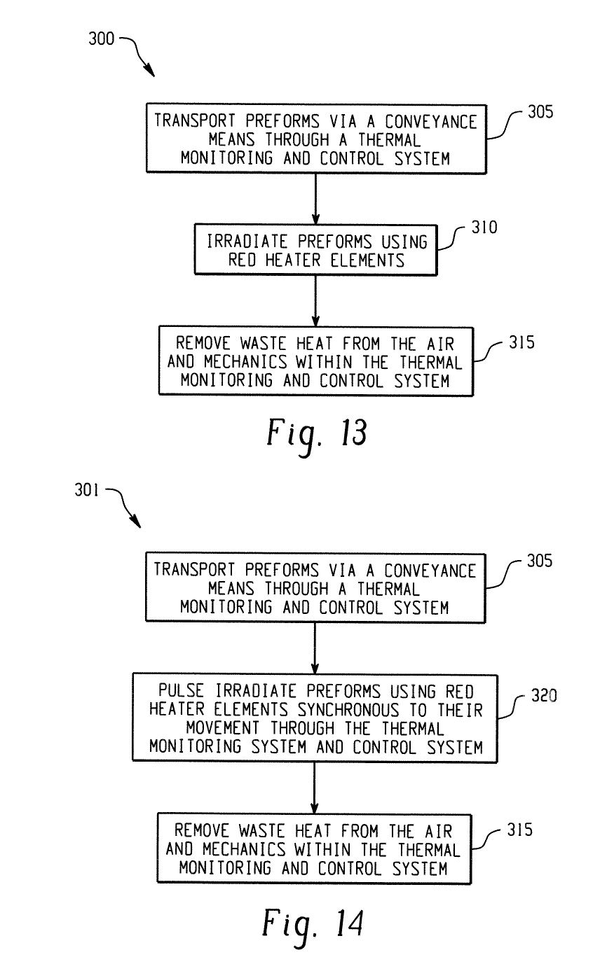

FIGS. 13-16 illustrate methods according to the present invention. It should be appreciated that these methods may be implemented using suitable software and hardware combinations and techniques. For example, the noted hardware elements may be controlled by a software routines stored and executed with the temperature control system 280.

Referring now to FIG. 13, a preferred method 300 for the thermal treatment of thermoplastic preforms is shown outlining the basic steps of operation. Preforms 240 are transported via a conveyor 250 through a thermal monitoring and control system 210 (Step 305). Of course, it should be understood that, with all embodiments showing conveyance, a simple means to locate the articles for exposure, with or without conveyance, may be employed. The preforms 240 are irradiated using narrow band irradiation, or RED, heater elements 100 contained within the thermal monitoring and control system 210 (Step 310). It should be appreciated that the narrow band irradiation heater elements may be pulsed or continuously activated for specified amounts of time during this process. In one embodiment, it will be understood that the preform may be sufficiently heated in less than 3 seconds—just prior to blow molding. In some forms, the preform may be heated in less time, e.g. less than 2 seconds, less than 1 second, or less than one-half second. In other embodiments, the heating may be accomplished in approximately 5 seconds or less, or approximately 10 seconds or less. This short heating time represents a significant advancement over conventional heating methods using quartz lamps, for example. Current quartz lamps based ovens typically heat for 12 to 15 seconds plus interspersed periods of equalization. To achieve such a short duration, the arrays of heater elements may be configured to provide sufficient heat to the preform in a substantially more confined physical space. The narrow band irradiation elements may be overdriven if desired to achieve the amount of energy required to heat the preform in 0.1-3 seconds. It is advantageous to make sure the arrays of diodes or solid state devices are kept continuously and consistently cool so they do not have early failure. This short duration of radiation may be achieved using any of the embodiments described herein including those in connection with FIGS. 14-25. Also, the number of revolutions or the speed of revolution may be varied during heating. Typically, six revolutions are used to heat a preform, but less or more may be used to vary the heating. Also, the speed of revolution or the amount of irradiation may be varied to smooth out the heating profile at the beginning and end of the heating process. It should also be understood that the devices contemplated herein to achieve this short heating duration include, in at least one form, devices having an extended life, such as Indium phosphide based devices noted above. These devices may also operate in a variety of ranges to produce desired bands. For example, for PET preforms, selection of wavelength bands greater than 1.2 microns may be desired. Further, the system may include elements that emit in a band, or range, greater than 1.2 microns and elements that emit in a band, or range, less than 1.2 microns. A convection cooling system 260 is used to remove waste heat from the air and mechanical components within the thermal monitoring and control system 210 (Step 315).

Another method 301 for the treatment of thermoplastic preforms is outlined in FIG. 14. In method 301, (Step 310), the process of irradiating preforms 240 using RED heater elements 100, is replaced with Step 320. During Step 320 of method 301, preforms 240 are pulse irradiated synchronously to their motion through the thermal monitoring and conditioning system 210. This synchronous, pulse irradiation provides substantial additional energy efficiency because the narrow band irradiation, or RED, devices nearest the perform are the only ones that are turned on at any given instant. In one form, the maximum output of the pulsed energy is synchronously timed to the transport of individual targets.

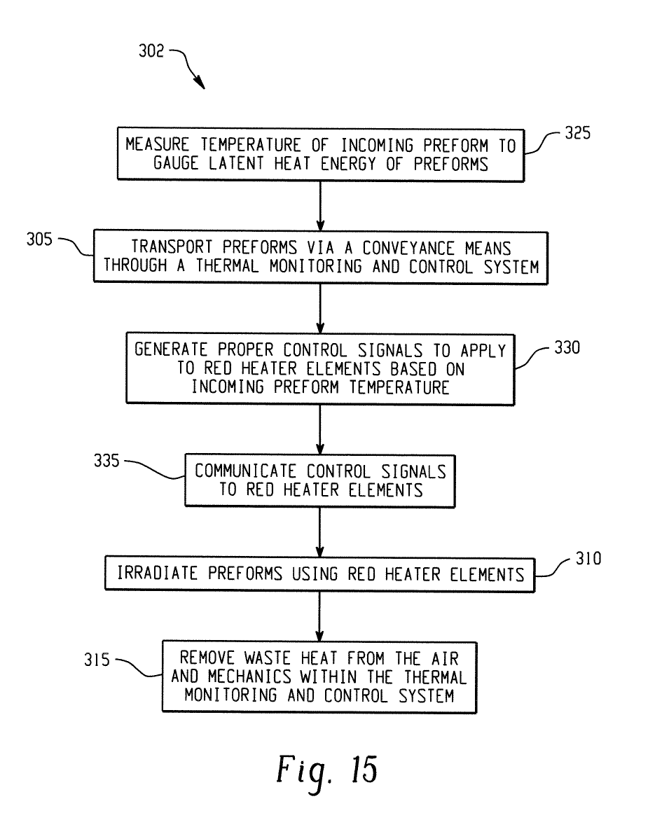

Yet another method 302 for the treatment of thermoplastic preforms is outlined in FIG. 15. In this method 302, the temperature of incoming preforms 240 is measured using temperature sensors 270. This is done to gauge the latent heat energy of preforms 240 as they enter into the system (Step 325).

It should be appreciated that temperature sensing may be implemented in a variety of manners. In one example, both the inner and outer temperature of a preform are measured so that the ultimate heating of the preforms can be tailored to accommodate the heating objectives of the system in place. Further, it should be understood that the measurement of temperature of the inner and outer surface of the preform can be accomplished using a number of known techniques. As an example, snap action technology disclosed in U.S. Ser. No. 10/526,799 (U.S. Publication No. 2006-0232674-A1—published Oct. 19, 2006), filed Mar. 7, 2005, entitled “An Apparatus and Method for Providing Snapshot Action Thermal Infrared Imaging Within Automated Process Control Article Inspection Applications,” and U.S. Ser. No. 10/753,014 (U.S. Publication No. 2005-0146065-A1—published Jul. 7, 2005—now U.S. Pat. No. 7,220,378 B2), filed Jan. 7, 2004, entitled “A Method and Apparatus for the Measurement and Control of Both the Inside and Outside Surface Temperature of Thermoplastic Preforms During Stretch Blow Molding Operations,” both of which are incorporated herein by reference, may be used to achieve this objective.

In any event, for example, if it is found that the inner temperature of the preform is lower than the outer temperature of the preform, and even heating is desired, techniques to heat the inner portions of the preform at a higher rate may be implemented to result in even heating. For some applications, it may be that uneven heating is desired. Measuring the inner and outer temperatures of the preform and implementing an appropriate heating cycle can then be accomplished.

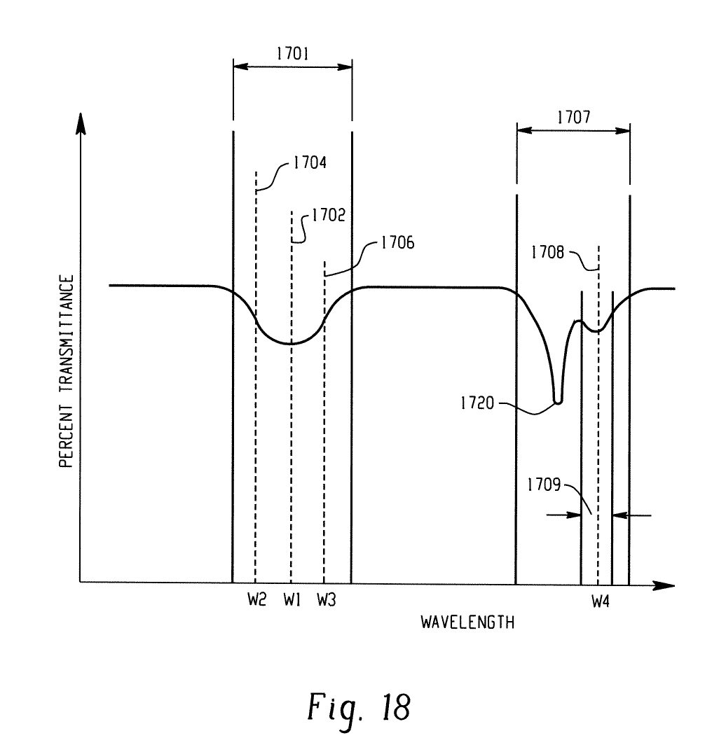

One technique to realize uneven heating between the outer surface and inner surface of the preform is to take advantage of the principles of the absorption curve for the particular material being used. In this regard, with reference now to FIG. 18, an absorption curve 1700 is shown. As shown, a first absorption band 1701 is defined. To achieve even heating through thickness of the preform, it has been found that selection of a wavelength W1 at the center line of the band, i.e. line 1702, is advantageous. It has also been found, however, that selecting a wavelength at one end (e.g. W2) or the other (e.g. W3), of an absorption band, e.g. line 1704 or 1706, provides uneven heating from the outer surface to the inner surface of the preform. It should be noted that the wider the range of different transmission or absorption coefficients that are included in the bandwidth of the irradiation source, the more uneven the heating will be through the thickness of the material. It follows then that W2 or W3 would tend to have less consistent heat through the thickness of the material being heated than W1.

It has been further determined that this phenomenon is local in nature. So, with reference to the absorption band 1707 in FIG. 17, even heating of the preform is accomplished by selecting a wavelength for corresponding to center line 1708. So, a narrower absorption band 1709 in this case is desirously selected even though the narrower absorption band is actually within a larger absorption band 1707 because it has a smaller range of absorption propensities within its range. In this regard, using extremely narrow band irradiation of, for example 20 nanometers or less, can be advantageous to concentrate most of the energy in a local absorptive feature. It should be appreciated that implementation of these techniques and selection of the wavelengths, e.g. W1, W2, W3 or W4, can be achieved using a variety of techniques. Also, better consistency can be achieved by selecting the band 1709 because the width of this range covers less variance in terms of the % transmittance, or y-direction on the graph, than, for example, a similar range that might be selected around the dip 1720.

Along these lines, it should be appreciated that knowledge of the absorption curve for a target is advantageous inasmuch as bands of irradiation can be selected to achieve desired results. So, in some applications, it may be desired to irradiate a target at a narrow band around W1 as well as narrow band around W4. It may also be desired to heat evenly in one band and unevenly in another band, as described above. This may result in the total exposure of the target at any given location to be the sum of the irradiation at different bands. So,

Total Exposure=xW1+yW4

for a given application, where x and y represent an amount of exposure of the target at the given wavelength band surrounding W1 and W4.

The preforms 240 are then transported via a conveyor 250 through a thermal monitoring and control system 210 (Step 305). A temperature control system 280 using the temperature information supplied by the temperature sensors 270 to generate a preferred control signal to be applied to the narrow band irradiation, or RED, heater elements 100 (Step 330). The preferred control signal is then communicated from the temperature control system 280 to the heater elements 100 (Step 335). The preforms 240 are then irradiated using the heater elements 100 contained within the thermal monitoring and control systems 210 (Step 310). A convection cooling system 260 is then used to remove waste heat from the air and mechanical components within the thermal monitoring and control system 210 (Step 315).

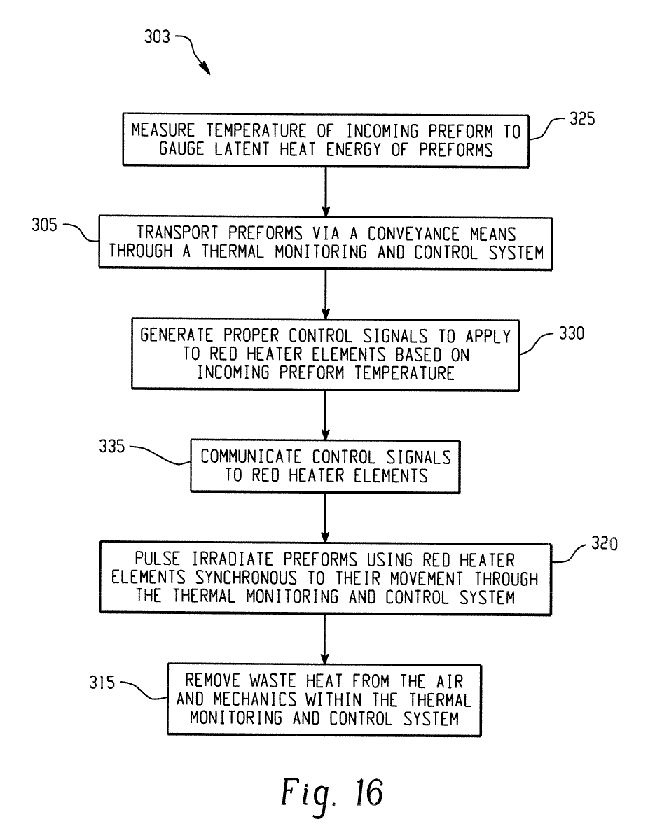

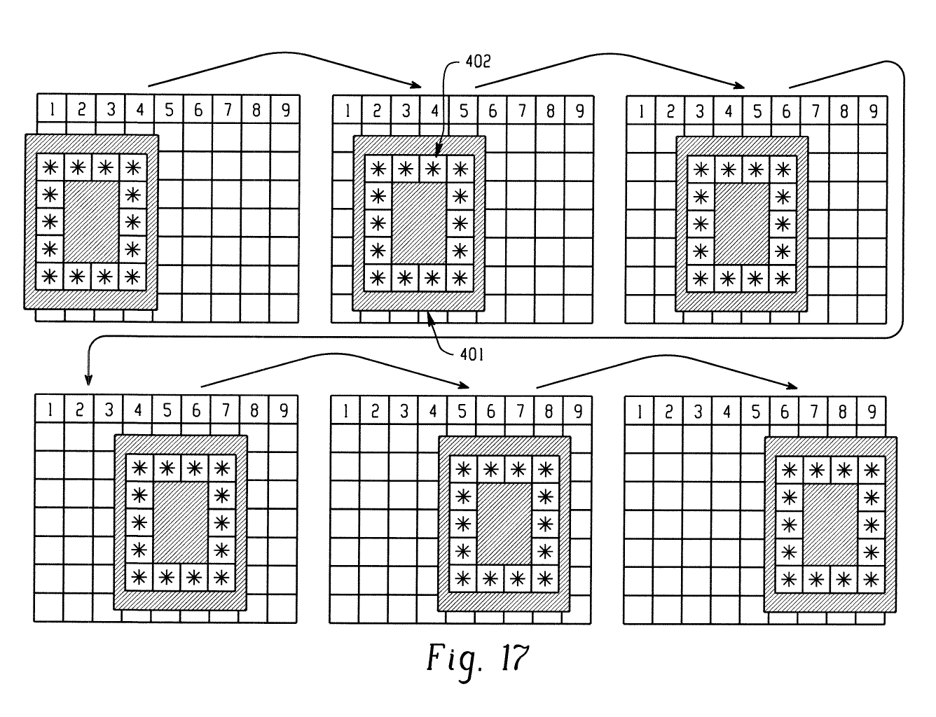

Still another method 303 of the treatment of thermoplastic preforms is outlined in FIG. 16. In method 303, Step 310, the process of irradiating preforms 240 using RED heating elements 100, is replaced with Step 320. During Step 320 of method 303, preforms 240 are pulse irradiated synchronously to their motion through the thermal monitoring and conditioning system 210.

In an alternative embodiment, the narrow band irradiation array may take a variety of different forms. Among these forms, the elements are disposed on stations that travel, either a rotary fashion, linear fashion, or other programmed path along with a respective passing preform to enhance the heating process. In this regard, it should be appreciated that the following embodiments are provided as examples only and may be implemented in a variety of different manners.

It should be understood that by spinning the preform, the irradiation heating effect can be more consistently uniform around the axis of rotation. While it may be desirable to have a different temperature profile for each preform as a function of distance from the neck ring (finished thread end), it is atypical to want a different temperature profile around the axis of rotation with a round bottle. Having recognized that it is atypical, there is a whole class of bottles for which it is very desirable to have a non-uniform heat profile around the perimeter of the preform. The ability to use this invention's capability to turn the radiation off and on very quickly or to modulate the irradiation in synch with the target will lend itself to capably heat to any desired heat profile. That profile can be very complex if the irradiation is programmed to change as both a function of preform height location as well as its rotary position. Such specialized heating is often called selective heating in the PET bottle industry but has never had the extremely programmable flexibility that this present invention provides.

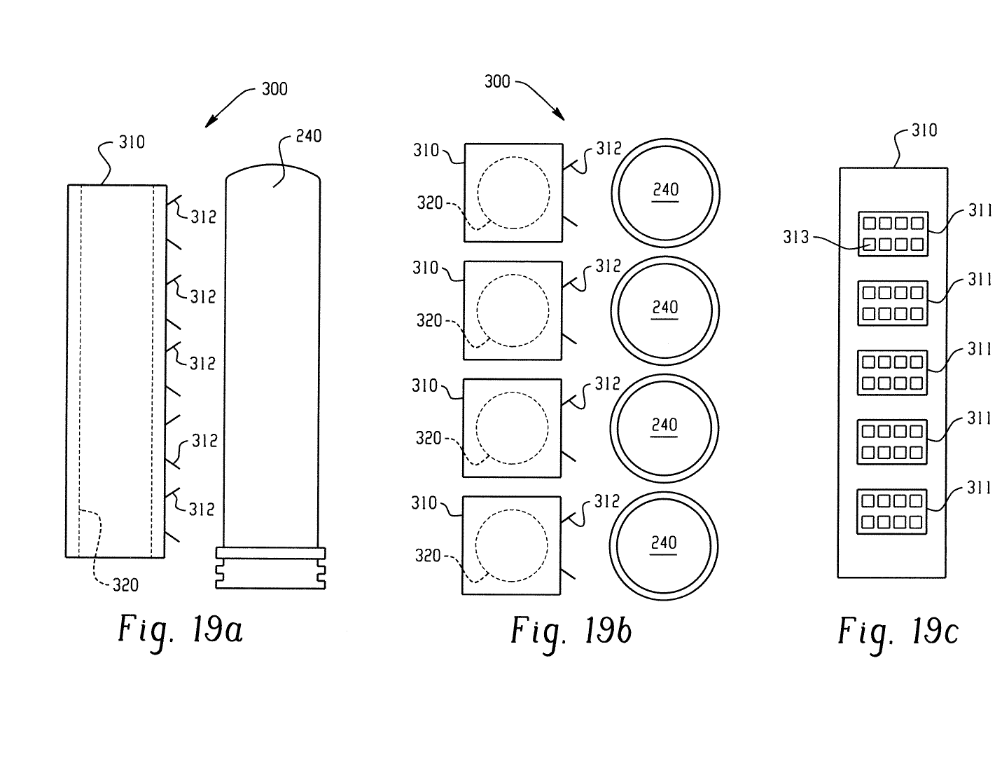

With reference now to FIG. 19(a), a side view of a system 300 is shown. It should be appreciated that the system 300 would act as an alternative for the arrays 210 that are provided in FIG. 12. For ease of reference, all components of the system illustrated in FIG. 12 are not shown; however, those of skill in the art will appreciate how the system 300 may be implemented therein. Moreover, only a single side of the system 300 (as well as system 400 to be described in greater detail below) is shown for ease of illustration.

As shown, the system 300 includes narrow band irradiation array 310, which may take the form of a linear array having emitters or arrays of emitters aligned along its length, having emitting devices (which emit in a narrow band) 312 disposed on a side thereof. As shown, the narrow band radiation devices or REDs 312 act on an exemplary preform 240 that may be passing through the system. Also shown in phantom is a shaft 320 about which the array 310 rotates. In FIG. 19(b), a plurality of arrays are disposed along a length of the conveyor line to accommodate several preforms 240. FIG. 19(c) illustrates an embodiment of the array 310 wherein a plurality of arrays 311 having emitters (such as emitter 313) disposed in an x by y manner along the length of the array 310. The number of arrays and emitters, of course, will vary. This configuration may also be applied to all embodiments described herein.

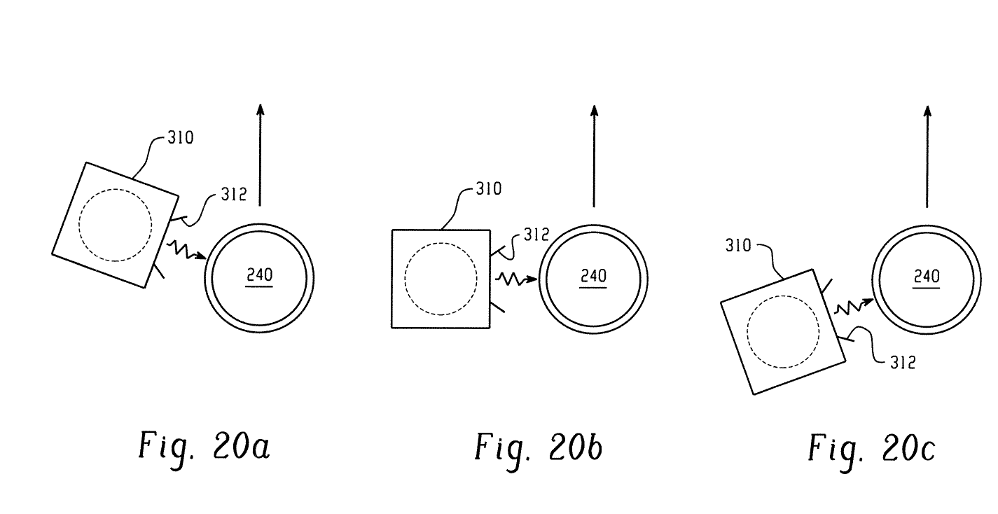

With reference now to FIGS. 20(a)-20(c), a basic operation of the array 310 is illustrated. As shown in FIG. 20(a), the array 310 rotates to emit suitable radiation upon the preform 240 as the preform 240 enters a zone near the linear 310. As shown in FIG. 20(b), as the preform 240 passes by the array 310, the array 310 rotates, or travels, with the preform to continue emitting radiation thereupon. FIG. 20(c) illustrates a further rotation of the array 310 about the shaft 320 to continue to irradiate upon the preform 240.

It should be appreciated that the implementation of the array 310 as a rotatable element may be implemented in the system in a number of manners. In one form, only a single array 310 may be provided, whereupon the single array 310 acts upon each and every preform that is processed through the system. In an alternative embodiment, a plurality of arrays 310 will act upon each single preform as it passes through the system.

Of course, suitable detectors, actuators, and sensors would also be installed on the system to allow for synchronization of the rotation of the arrays along with the propagation of preforms. There are many methodologies to effect the synchronized motion of the irradiation from the arrays which would include servoing, mechanical linkages, galvanometers, or cam actuation.

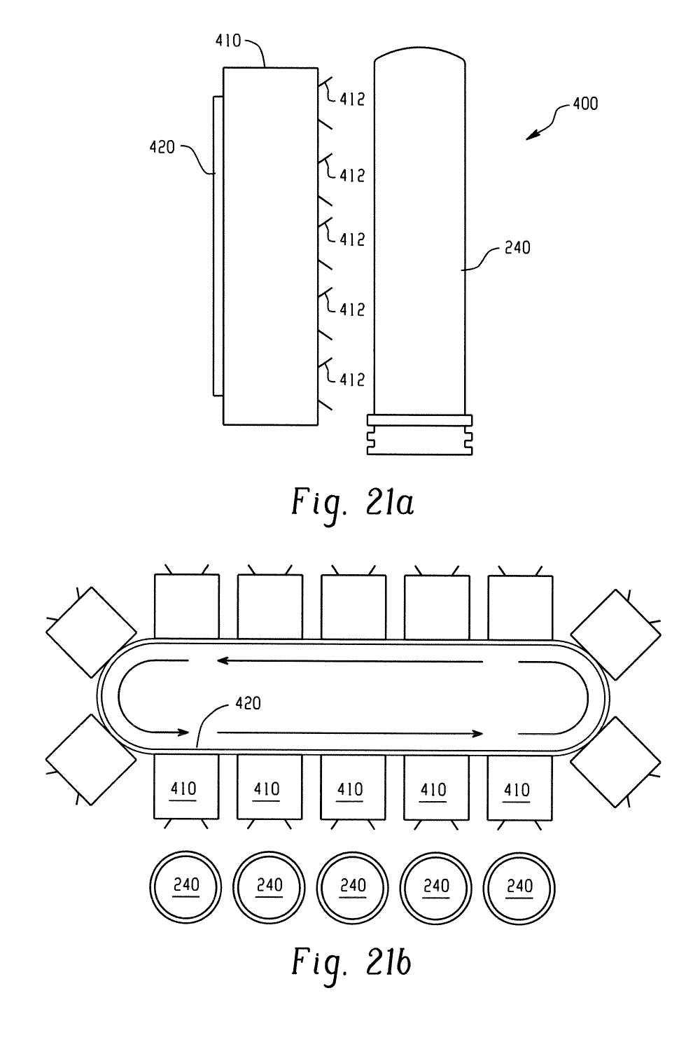

In a still further embodiment, with reference now to FIGS. 21(a)-21(b), a system 400 may be implemented. In FIG. 21(a), a generally linear array 410 is shown in relation to a preform 240. It should be appreciated that the preforms, at least in one form, are spinning or being indexed to rotate about its axis. The arrays 410 or elements (or arrays of emitters) 412 may be selectively activated and deactivated to heat the preform 240, as has been described herein. Also shown in FIG. 21(a) is a conveyor element 420.

With reference now to FIG. 21(b), a top view of the system 400 shows that each irradiation array 410 is synchronized with the progress of a preform 240 through the heating zone and then rotates around on the conveyor to act on additional preforms. Like the embodiments illustrated in FIGS. 19 and 20, it should be appreciated that the embodiment of FIG. 21 may take a variety of different forms than is illustrated. However, in each of these forms, the array 410 will, in some fashion, follow the path of the preform 240 to provide radiation treatment to the preform 240. As an alternative, instead of using a loop such as that provided by the conveyor 420, the operation may be strictly linear—whereby the set of arrays follows the respective preforms for a predetermined distance along a rail or track and then is reversed or returned to be synchronized with another set of preforms. Such a system might include a linear track and/or rail system whereby the complications of rotary movements of belts would not be necessary. The rotary movement of such a system might merely include a gear engaging the teeth of the track or rail, or it may be driven by a servo motor drive system which can provide a more programmable method of synchronization.

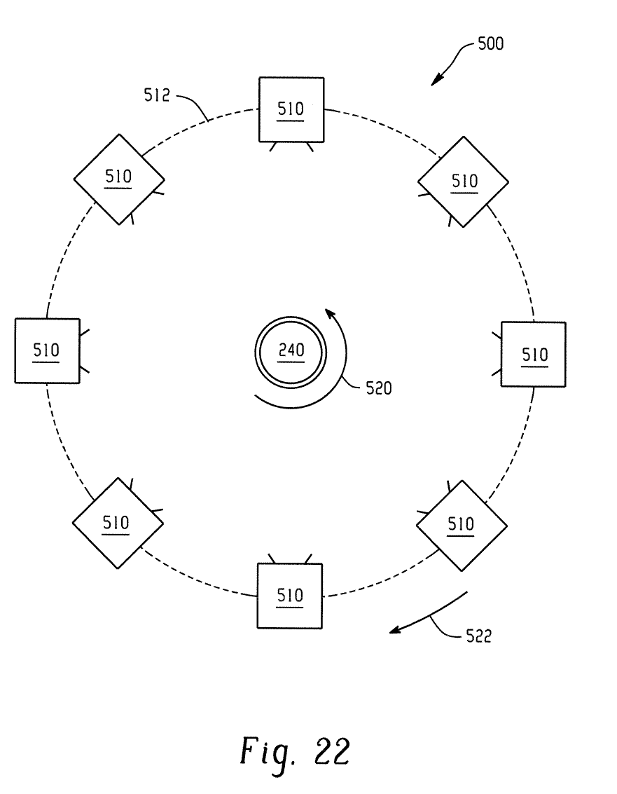

In still a further embodiment, with reference to FIG. 22, the arrays may be positioned around the circumference of a preform at a heating station to emit the requisite radiation. In this case, either the preform may be rotated or the arrays may be spun around the preform. As shown, a system 500 includes a plurality of arrays 510 disposed around the circumference of the preform 240. Again, the preform may be rotated in a direction such as that shown by the arrow 520. Alternatively, the circular configuration of generally linear arrays 510 may be rotated by known techniques in a direction, such as direction 522. Of course, it should be appreciated that both the array and the preform may be rotated. It should also be understood that the preform may be disposed within the system 500 in a variety of manners. For example, the preform may be conveyed into the system between arrays 510. Alternatively, the system 500 may be vertically translatable relative to the preform such that the system 500 can be translated downwardly to heat the preform and then translated upwardly to allow the preform to pass.

Shown also in FIG. 22 is a mirror 512 which is shadowed in because it could optionally be placed as shown. FIG. 22 shows eight (8) irradiation heads 510 which have been configured to irradiate the preform 240. The number of irradiation heads could vary from one to any desirable number N that would fit within the geometry of the engineered system. It is highly desirable to have the irradiation heads 510 located radially so that they are not aiming energy directly at another through the preform. The mirror 512 can be designed to fill in any empty space between irradiation heads and can also be used to substitute if there is no irradiation head in a given location. If for example, there were only one irradiation head 510 irradiating preform 240, then the mirror could be a complete circle minus the space through which the irradiation must take place. As the irradiation energy is emitted from the irradiation head 510, it travels toward the preform 240 forming typically a diverging beam. As the irradiation energy rays travel through the preform they encounter up to four different interfaces. There is one air-to-plastic interface when it hits the outer wall of preform 240, one when it leaves the outer wall of preform 240 and travels in the “inner space” of preform 240. Then the third interface is when it strikes the inside of the wall of preform 240, and the fourth interface with the air is when the energy ray exits the outside wall of preform 240. It has been previously taught in this patent application that photons are absorbed exponentially by target materials according to a well understood mathematical formula and according to the specific absorption curve for the particular target material. As the energy ray passes through the first sidewall and then the second sidewall of the preform 240 it is continuing to lose photons which are absorbed by the target material and converted to heat. For very thick-walled preforms 240 the energy may be completely extinguished before it can exit the first sidewall and proceed to the second sidewall. This is dependent upon the wavelength that is chosen for the irradiation and what the target materials' absorption is at that wavelength. So if the irradiation energy has not been completely absorbed in the first sidewall any remaining energy will continue along the path, having been bent slightly by diffraction according to the geometry of the preform 240, and will proceed to the second sidewall. As the energy ray enters the second sidewall of preform 240 it again encounters a change of material and its directional vector will be bent as it enters the second sidewall according to the angle of incidence and the geometry of the preform 240. Again, assuming that there is still energy in the irradiation beam that is not absorbed in the second sidewall, the photons 519 continue and will impact the mirror 512 and be reflected back toward the preform 240. It then starts the path through each of the walls of the preform again. If the wavelength is well chosen for the PET preform thickness, there is no energy left to leave the second wall after the ray 517 makes its round trip through the preforms. By using this mirror technique it is possible to design the system to handle a larger range of preforms with a particular wavelength. The design goal is to extinguish 100% of the irradiation through absorption in the first pass through the preform 240 but since systems typically are designed to handle a range of preform 240 thicknesses and geometries, the mirrors will salvage and return a substantial percent of the energy that might otherwise be wasted.

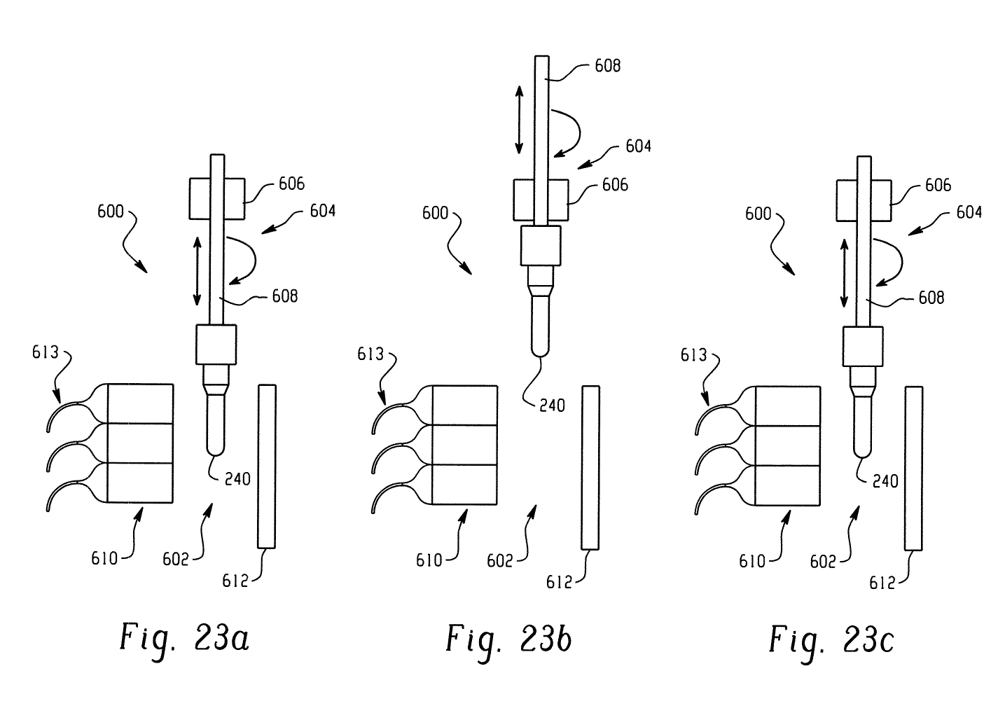

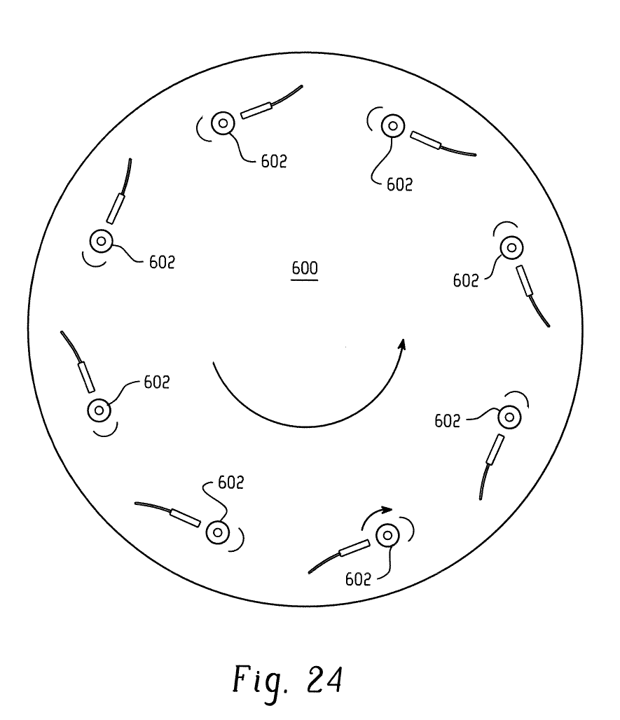

A still further embodiment is illustrated in FIGS. 23 (a), 23 (b), 23 (c) and 24. As shown in FIGS. 23 (a)-(c), a system 600 facilitates the heating of a preform 240 that is staged in a heating zone 602. The preform 240 is supported by a staging system 604 that is translatable from a first position outside the heating zone (FIG. 23 (b)) to a second position inside the heating zone (FIGS. 23 (a) and 23 (b)). The staging system 604 includes a motor device 606 and a piston device 608. The motor device 606 is operative to translate the piston device 608 from the first position to the second position, as noted above. The motor device 606 is also operative to rotate the piston device 608. Of course, this functionality facilitates heating the preform in the advantageous manners, including those noted above (e.g. for a specified length of time such as 3 seconds or less. The heating zone 602 is defined by an array or head 610 and a mirror 612. It will be appreciated that the array or head 610 emits radiation at selected wavelength(s), which radiation is absorbed by the preform or reflected off the mirror.

The array 610 may take a variety of forms. In one form, the array 610 includes a series of linearly positioned narrow band irradiation elements or arrays of emitters, as noted above. The array 610 may also include multiple arrays or blocks that are modular in nature to accommodate varying sizes of targets or preforms. In such a form, the elements 613 may relate to power supply and control lines for the arrays. In another form, as shown, the head includes a series of lenses or openings that communicate with the narrow band irradiation devices (e.g. laser diodes) through the use of lines 613, which could take the form of fiber optic lines. The blocks or arrays may be implemented in a variety of manners. For example, the fibers (or emitting devices) on the edges of the blocks may be fanned or varied in size to compensate for the physical characteristics of the edge of the block. This will facilitate more even emission and application of heat on the target. The spacing of the emitters or fibers, or the blocks, may also be varied to achieve more even heating. Likewise, the mirror 612 may take a variety of forms that achieve the objectives of the presently described embodiments.

FIG. 24 shows a top view of the system 600. Note that the heating zones 602 are configured in a circular arrangement. The appurtenant hardware devices noted above are provided for each heating zone. Of course, the precise manner in which the preforms are brought into the heating zones may vary from application to application; however, the circular nature of the configuration will lend itself to a variety of convenient approaches including a vertical translation up or down into the heating zone or cavity, in a direction roughly parallel to the axis of rotation of the oven base plate.

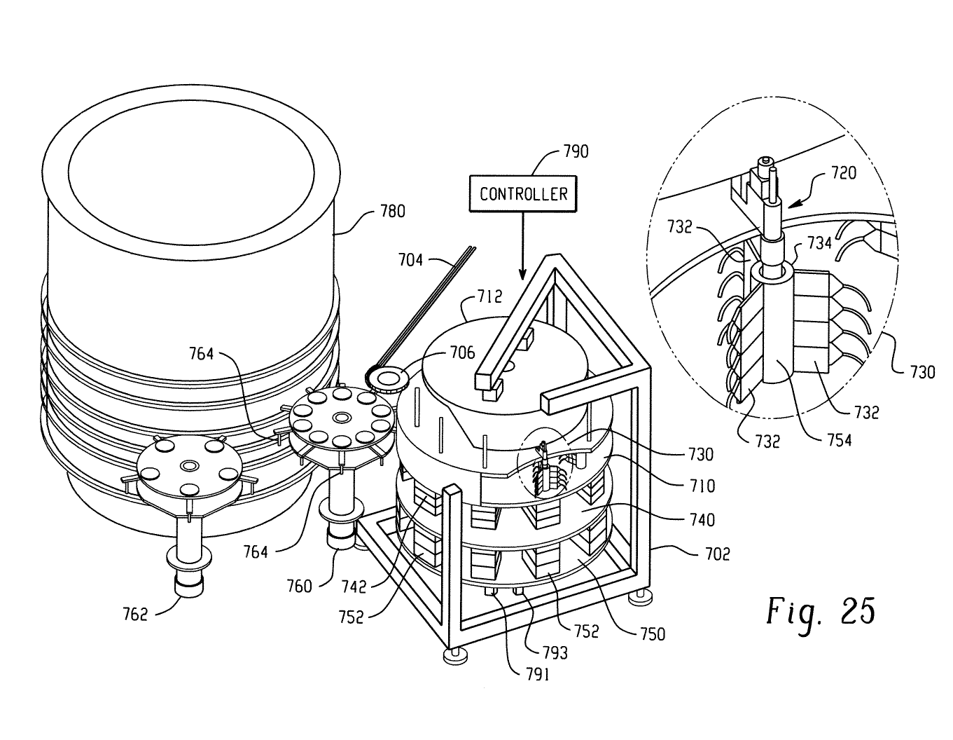

The embodiments of FIGS. 23 (a)-(c) and 24, and others described herein, may be implemented in a variety of environments. One such environment is illustrated in FIG. 25. As shown, a system 700 includes an oven 702, transfer spindles 760, 762 and a blow molder 780. It should be appreciated that the blow molder is only representatively shown for ease of reference. Also representatively shown is a controller 790 for controlling the rotatable oven 702 and/or controlling the sensing of temperatures (and other parameters) or irradiation devices in any of a variety of manners. For example, control of the current may be advantageous where a large number of devices at relatively high power are used to achieve, in one form, a 48 volt drive level with a current source power supply. The controller may take a variety of forms and may use a variety of software routines and hardware configurations. Sensors in the system may be incorporated into the control system as well. Those of skill in the art will understand the basic operation thereof. In addition, other components (not specifically shown) such as cooling devices, rotation mechanism, motors, . . . etc. may also be implemented.

The transfer spindle 760 is operative to transfer preforms from a track 704 to the oven 702. It should be appreciated that the track 704 terminates in a transfer gear 706. The transfer spindle 760 has transfer arms 764 that transfer the preforms from the transfer gear to a staging device 720 of the oven. The staging device 720 receives the preform and translates it around and through the oven 702. In this regard, the preform is translated down to the heating cavity layer 710 of the oven. This may be accomplished in a variety of manners but, in one form, a cam 712 that forces the staging device 720 toward the heating cavity layer 710 as the staging device 720 rotates around the oven 702. The heating cavity layer 710 includes a plurality of heating cavities 730. Each heating cavity is defined by arrays or heads, such as the three heads 732, and mirrors 734 which form a cylindrical cavity, or irradiation station or contaminant vessel, that is sized to receive the preforms. In this form, the oven 702 also includes a radiation source layer 740 which includes a plurality of radiation sources 742. As shown, the radiation sources include a plurality of radiation emitting arrays as described herein. The emitted radiation from these arrays is communicated through fiber optic lines 736 to the heads 732. Of course, it should be understood that the use of fiber optics is merely one configuration that may be implemented. It should be appreciated that the radiation emitting array may also be positioned in the place of the heads so as to provide direct emission from the arrays to the preform. This would eliminate the need for a radiation source layer.

The oven 702 also includes a power source layer 750. The power source layer 750 includes a plurality of power sources that are positioned to provide power to the radiation source layer and other components within the oven.

In operation, preforms are translated down the track 704 to the transfer spindle 760. The transfer spindle 760 transfers the preforms to staging devices of the oven 704. The staging devices 720 are rotated by and around the oven to the heating cavity layer 710 where the preforms are received within heating cavities and further rotated around the oven. While in the heating cavity, the preform is rotated at so that a particular heating profile can be achieved. For example, the preform may be rotated at a different speed at the beginning and/or end of the heating process to achieve more even heating and to reduce the effect of a “start/stop” line, e.g. by implementation of a servo-motor or stepper motor and appropriately interfaced controller. The heating of the preform may be conducted for, as noted above, three seconds or less. Once the cavity in which the preform is being heating is rotated substantially around the oven, the preform is removed from the cavity, in much the same manner that it was placed in the cavity, e.g. by the cam 712. The preform is then grabbed by the transfer spindle and rotated to the blow molder 780 for processing. The transfer spindle 762 then retrieves the blown bottles from the blow molder, as shown.

It should be understood that the embodiments described herein (such as those described in connection with FIGS. 18-25, as well as the others) will most advantageously incorporate control, sensing, and feedback functions (and other functions such as cooling) to allow for closed-loop operation of the system. So, the systems are controlled to facilitate heating of individual preforms to attain a correct heat profile for that particular preform. This profile may include a profile over its length or about the rotational perimeter of the preform about its long axis. Some of the embodiments described herein do not show specific modules (such as module 280 of FIG. 12 or controller 790 of FIG. 25) for accomplishing control, sensing and feedback for ease of application; however, it should be understood that such modules could be incorporated therein in manners similar to those embodiments where such functionality is discussed in more detail. It should be understood that cooling functions may also be implemented through various means. For example, cooling functions may be used to remove waste heat to another desired location (which could be inside or outside the plant or the system). In, for example, FIG. 25, cooling may be accomplished by running liquid cooling lines into and out of the system at, for example, an inlet 791 and outlet 793. Appropriate cooling branches (not shown) may be provided to the heating cavities. The outlet 793 could be attached to suitable structure to remove the waste heat from the area or system.

Along these lines, it should be appreciated that the embodiments of the present invention, including the rotating type of embodiments of FIGS. 22-25, may include the following features, depending on the application:
the rotatable mounting arrangement is a rotational oven configuration in which irradiation stations or heating cavities correspond to each target that is being heated in the oven at any given time and each target that is being heated in the oven at said given time can be heated by the corresponding irradiation station.
the configuration includes more than one irradiation station or heating cavity and each irradiation station can be controlled separately by a controller (such as controller 790) and/or the means for supplying electrical current to heat the corresponding target.
the configuration, through, e.g. the controller 790, includes sensing target heat parameters and controlling the means for supplying electrical current to control each irradiation station or heating cavity accordingly.
sensing target heat parameters through, for example, the controller 790, includes sensing one of target heat or target heat profile of each individual target entity, determining from the sensing information the irradiation heat injection needs of each individual target entity and, sending control signals to the means for supplying electrical current to the at least one narrow band irradiation element irradiate the target entity accordingly.
the system comprises a mechanical arrangement of rotating each target entity in the irradiation field of view of the corresponding irradiation station.
the target entity being injected with radiant energy is a plastic bottle preform in preparation for being blown into a bottle in a subsequent operation.
each of the irradiation stations is designed as a containment vessel into which the target entity can be inserted for irradiation and such that the motion direction for insertion is substantially parallel to the axis of rotation of the main oven.
at least one of electrical power or cooling liquid is supplied for use in the rotatable portion of the oven through a rotary connection.
the mounting arrangement comprises a plurality of linear arrays of the at least one narrow band irradiation element.
the linear arrays are translatable along a path of the target.
the system includes at least one optical element for directing irradiation into selected heating zones.

The above description merely provides a disclosure of particular embodiments of the invention and is not intended for the purpose of limiting the same hereto. As such, the invention is not limited to only the above-described applications or embodiments. This disclosure addressed many applications of the invention broadly and one application embodiment specifically. It is recognized that one skilled in the art could conceive of alternative applications and specific embodiments that fall within the scope of the invention.

What is claimed is:

1. A system for non-contact thermal treatment of plastic target components having multiple layers or absorption peaks prior to molding or processing operations comprising:
a means operative to locate the plastic target components in a manner facilitating the application of radiant heating; and
a thermal monitoring and control section into which the plastic components are located for exposure, the thermal monitoring and control section comprising a first set of one or more solid state narrow band heating elements operative to emit radiant energy of at least a first narrow wavelength band matching desired absorptive characteristics of a first layer of the components and a second set of one or more solid state narrow band radiant heating elements operative to emit radiant energy of at least a second narrow wavelength band.

2. A method of thermally treating thermoplastic preforms prior to stretch blow molding operations, the method comprising the steps of:
transporting a series of preforms through selected heating zones of a thermal monitoring and control section of a blow molding machine;
rotating each of the series of preforms in at least one heating zone; and,
irradiating the each of the preforms while rotating using narrow band irradiation-based radiant heating elements for a period of approximately ten seconds or less, whereby the preforms are desirously, properly heated for further treatment, the narrow band elements being operative to emit radiation in a narrow wavelength band.

3. The method as set forth in claim 2 wherein less than 10 seconds comprises one of less than 5 seconds, less than 3 seconds, less than 2 seconds, less than 1 second and less than one-half second.

4. The method as set forth in claim 2 further comprising the steps of:
measuring temperature of an inner surface and an outer surface of incoming preforms to gauge latent heat content prior to entering the thermal monitoring and control section;
generating control signals to apply to the narrow band radiant heating elements based on the incoming preform temperatures; and
communicating these control signals to the narrow band radiant heating elements to achieve a desired heat profile for the preforms.

5. The method as set forth in claim 4 further comprising measuring each preform individually.

6. The method as set forth in claim 2, further comprising irradiating each individual preform, to attain the correct heat for that preform using the narrow band heating elements, which elements have usable life greater than 10,000 hours.

7. The method as set forth in claim 6, further comprising irradiating each individual preform according to the heat injection required to attain a desired heat profile over the length of the preform.

8. The method as set forth in claim 6, further comprising the capability to irradiate each individual preform according to the heat injection required to attain a desired heat profile around the rotational perimeter of the preform about its long axis.

9. The method as set forth in claim 4 wherein the desired cross-sectional heat profile results in preforms heated evenly from the outer surface to the inner surface.

10. The method as set forth in claim 4 wherein the desired cross-sectional heat profile results in preforms heated unevenly from the outer surface to the inner surface.

11. The method as set forth in claim 2 wherein the rotating comprises varying at least one of the speed of rotation or an amount of irradiation to achieve more even heating.

12. The method as set forth in claim 2 wherein the irradiating is in a range greater than 1.2 microns.

13. The method as set forth in claim 2 wherein the irradiating is preformed using at least one element emitting at greater than 1.2 microns and another element emitting at less than 1.2 microns.

14. A system for selectively injecting narrow band radiant heat into a target, the system comprising:
at least one solid state narrow band irradiation device element, the at least one narrow band irradiation element being operative to emit radiation in a narrow wavelength band of radiant heat output for an associated application with the target, the narrow wavelength band being selected to correspond with the specific absorption characteristic of the associated target material.
a mounting arrangement to position the at least one narrow band irradiation element such that irradiation therefrom is aimed at the target, the mounting arrangement being operative to allow the aimed radiation to follow the target while the target is in a heating zone; and
a means for supplying electrical current to the at least one narrow band element whereby a direct electrical current-to-photon radiation conversion process occurs.

15. The system and method as set forth in claim 14, further comprising a system of irradiation which uses a wavelength of radiation which has been chosen to specifically correspond to the absorptive qualities of the target material to have a desired level of radiant heating through a cross-section of the target.

16. The system as set forth in claim 14 wherein the mounting arrangement comprises a rotatable element.

17. The system as set forth in claim 16 wherein the rotatable mounting arrangement is a rotational oven configuration in which an irradiation station corresponds to each target that is being heated in the oven at any given time and each target that is being heated in the oven at said given time is heated by the corresponding irradiation station.

18. The system as set forth in claim 17 wherein the configuration includes more than one irradiation station and each irradiation station can be controlled separately by the means for supplying electrical current to heat the corresponding target.

19. The system as set forth in claim 18 wherein the configuration includes sensing target heat parameters and controlling the electrical current supplied to control each irradiation station accordingly.

20. The system as set forth in claim 19 wherein sensing target heat parameters includes sensing one of target heat or target heat profile of each individual target entity, determining from the sensing information the irradiation heat injection needs of each individual target entity and, sending control signals to the means for supplying electrical current to the at least one narrow band irradiation element irradiate the target entity accordingly.

21. The system as set forth in claim 18 further comprising a mechanical arrangement of rotating each target entity in the irradiation field of view of the corresponding irradiation station.

22. The system as set forth in claim 21 wherein the target entity being injected with radiant energy is a plastic bottle preform in preparation for being blown into a bottle in a subsequent operation.

23. The system as set forth in claim 18 wherein each of the irradiation stations is designed as a containment vessel into which the target entity can be inserted for irradiation and such that the motion direction for insertion is substantially parallel to the axis of rotation of the main oven.

24. The system as set forth in claim 16 wherein at least one of electrical power or cooling liquid is supplied for use in the rotatable portion of the oven through a rotary connection.

25. The system as set forth in claim 14 wherein the mounting arrangement comprises a plurality of x by y arrays of the at least one narrow band irradiation element.

26. The system as set forth in claim 25 wherein the linear arrays are translatable along a path of the target.

27. The system as set forth in claim 23 wherein the containment vessel comprises a reflective enclosure, the shape of which is designed to reflect a substantial amount of irradiation energy that passes through the target back into the target.

28. A system for selectively injecting radiant heat into a target, the system comprising:
at least one solid state narrow band irradiation element, the at least one narrow band irradiation element being operative to emit radiation in a narrow wavelength band of radiant heat output for an associated application with the target, the wavelength being selected to correspond with the specific absorption characteristic of the associated target material;
a mounting arrangement to position the at least one narrow band irradiation element such that irradiation therefrom is aimed at the target, the mounting arrangement being configured to define at least one heating zone and selectively receive the target entities into which radiant heat is injected from the at least one narrow band irradiation element in the heating zone, the arrangement having a rotatable element which transports target entities into and out of the at least one heating zone;
at least one optical element for directing irradiation into selective heating zones; and
a means for supplying electrical current to the at least one narrow band irradiation element.

29. The system as set forth in claim 28 wherein the heating zone is further defined by at least one mirror.

30. The system as set forth in claim 28 wherein the at least one narrow band irradiation element comprises an array.

31. The system as set forth in claim 30 wherein the mounting arrangement comprises a plurality of arrays defining a plurality of heating zones configured in a generally circular arrangement with respect to one another.

32. The system as set forth in claim 28, wherein the mounting arrangement facilitates use of fiber optics to convey and aim the radiation at the target material.

33. The system as set forth in claim 32 wherein the fiber optics may be fanned at selected areas to achieve even heating.

34. The system as set forth in claim 28 wherein the target entities comprise plastic bottle preforms which will be blown into a bottle in a subsequent operation.

35. A system for non-contact thermal treatment of preforms in a molding or processing operation, the system comprising:
a track for transporting the preforms;
an oven having a plurality of staging devices and corresponding heating cavities, the heating cavities providing irradiation of the preforms using narrow band emitting elements operative to emit radiation in a narrow wavelength band of radiant heat object to match desired absorptive characteristics of the preforms; and,
a transfer spindle operative to transfer preforms from the track to the staging devices, the staging devices being operative to be rotated to place the preforms into and out of the heating cavities, the transfer spindle being further operative to transfer the preforms to a blow molder.

36. The system as set forth in claim 35 wherein the irradiation of the preforms is completed in ten seconds or less.

37. The system as set forth in claim 35 further comprising an inlet and outlet for performing cooling functions in the system.
